(19) United States
(12) Patent Application Publication
(10) Pub. No.: US 2024/0376954 A1
(43) Pub. Date: Nov. 14, 2024

(54) SHOCK ABSORBER

(71) Applicant: HITACHI ASTEMO, LTD., Ibaraki (JP)

(72) Inventor: Takamasa KOTANI, Hitachinaka-shi (JP)

(21) Appl. No.: 18/689,884

(22) PCT Filed: Jul. 20, 2022
(86) PCT No.: PCT/JP2022/028156

§ 371 Date: Mar. 7, 2024

(30) Foreign Application Priority Data
Nov. 26, 2021 (JP) 2021-192030

(51) Int. Cl. F16F 9/348; F16F 9/06; F16F 9/19; F16F 9/504

(52) U.S. Cl. CPC F16F 9/3484; F16F 9/19; F16F 9/3485; F16F 9/062; F16F 9/065; F16F 9/504

(57) ABSTRACT

The shock absorber includes a cylinder sealing a working fluid, a piston slidably fitted in the cylinder and partitioning an inside of the cylinder into two chambers, a rod having a first end portion fastened to the piston and a second end portion protruding from the cylinder, a passage allowing communication between one chamber and another chamber in the cylinder, a bendable plate-shaped first valve having a first support part provided in the passage and supported at one surface on a radially inner side, a second support part disposed on a radially outer side relative to the first support part and supported at one surface, and a biasing part at least a part of which is provided on a radially outer side of the second support part to bias the second support part side, and a flexible member contacting the first support part and bendable together with the first valve.

### TECHNICAL FIELD

The present invention relates to a shock absorber.

Priority is claimed on Japanese Patent Application No. 2021-192030 filed on Nov. 26, 2021, the content of which is incorporated herein by reference.

### BACKGROUND ART

In shock absorbers, there is one that uses a bendable disc as a valve (for example, see Patent Document 1).

### CITATION LIST

### Patent Document

### [Patent Document 1]

Japanese Patent No. 6722683

### SUMMARY OF INVENTION

### Technical Problem

When a bendable plate-shaped valve is used, it is desired to enhance durability thereof.

Therefore, an objective of the present invention is to provide a shock absorber in which durability of a bendable plate-shaped valve can be enhanced.

### Solution to Problem

In order to achieve the above-described objective, a shock absorber according to one aspect of the present invention includes a cylinder in which a working fluid is sealed, a piston fitted in the cylinder to be slidable and partitioning an inside of the cylinder into two chambers, a rod having a first end portion fastened to the piston and a second end portion protruding from the cylinder, a passage allowing communication between one chamber and another chamber in the cylinder, a bendable plate-shaped first valve having a first support part provided in the passage and supported at one surface on a radially inner side, a second support part disposed on a radially outer side with respect to the first support part and supported at one surface, and a biasing part at least a part of which is provided on a radially outer side of the second support part to bias the second support part side, and a flexible member in contact with the first support part and bendable together with the first valve.

### Advantageous Effects of Invention

According to the above-described aspect of the present invention, durability of the bendable plate-shaped valve can be enhanced.

### BRIEF DESCRIPTION OF DRAWINGS

FIG. 1 is a cross-sectional view illustrating a shock absorber of a first embodiment according to the present invention.

FIG. 2 is a cross-sectional view illustrating a piston, a first damping force generation mechanism, a second damping force generation mechanism, a frequency sensitive mechanism, and the like of the shock absorber of the first embodiment according to the present invention. Specifically, this is an enlarged view of part A in FIG. 1. Further, the dashed dotted line indicated by reference sign CL indicates a central axis of the shock absorber.

FIG. 3 is a one-sided cross-sectional view illustrating a frequency sensitive mechanism and the like of the shock absorber of the first embodiment according to the present invention. Specifically, this is an enlarged view of part B in FIG. 2.

FIG. 4 is a one-sided cross-sectional view illustrating a frequency sensitive mechanism and the like of a shock absorber of a second embodiment according to the present invention. Specifically, this is an enlarged view of part B in FIG. 2.

FIG. 5 is a one-sided cross-sectional view illustrating a frequency sensitive mechanism and the like of a shock absorber of a third embodiment according to the present invention. Specifically, this is an enlarged view of part B in FIG. 2.

FIG. 6 is a one-sided cross-sectional view illustrating a frequency sensitive mechanism and the like of a shock absorber of a fourth embodiment according to the present invention. Specifically, this is an enlarged view of part B in FIG. 2.

FIG. 7 is a one-sided cross-sectional view illustrating a frequency sensitive mechanism and the like of a shock absorber of a fifth embodiment according to the Specifically, this is an enlarged view of part B in FIG. 2. present invention.

FIG. 8 is a one-sided cross-sectional view illustrating a frequency sensitive mechanism and the like of a shock absorber of a sixth embodiment according to the present invention. Specifically, this is an enlarged view of part B in FIG. 2.

FIG. 9 is a one-sided cross-sectional view illustrating a frequency sensitive mechanism and the like of a shock absorber of a seventh embodiment according to the present invention. Specifically, this is an enlarged view of part B in FIG. 2.

FIG. 10 is a one-sided cross-sectional view illustrating a frequency sensitive mechanism and the like of a shock absorber of an eighth embodiment according to the present invention. Specifically, this is an enlarged view of part B in FIG. 2.

### DESCRIPTION OF EMBODIMENTS

### First Embodiment

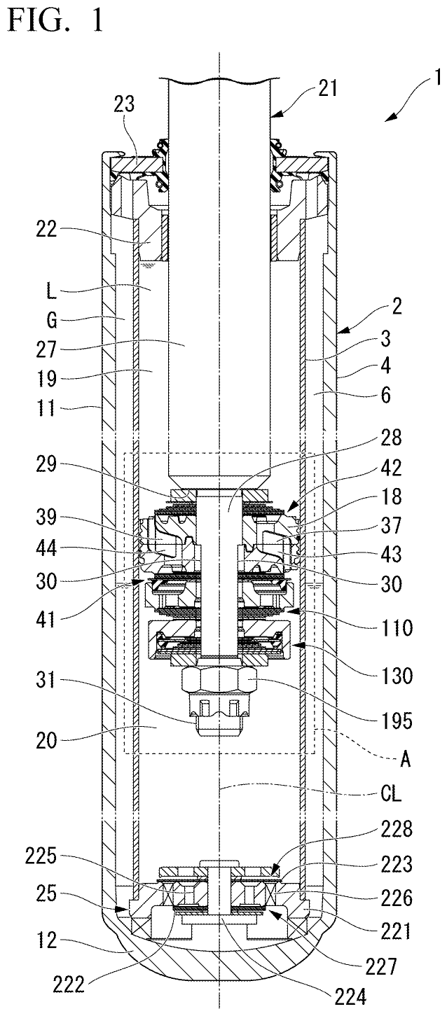

A shock absorber of a first embodiment will be described below with reference to FIGS. 1 to 3. Further, in the following, for convenience of explanation, an upper side in FIGS. 1 to 10 will be referred to using “upper,” and a lower side in FIGS. 1 to 10 will be referred to using “lower”.

As illustrated in FIG. 1, a shock absorber 1 of the first embodiment is a dual-tube type hydraulic shock absorber. The shock absorber 1 is used in suspension devices of vehicles, specifically, automobiles. The shock absorber 1 includes a cylinder 2 in which an oil fluid Lis sealed as a working fluid. The cylinder 2 has an inner cylinder 3 and an outer cylinder 4. The inner cylinder 3 has a cylindrical shape. The outer cylinder 4 has a bottomed cylindrical shape. The outer cylinder 4 has an inner diameter larger than an outer diameter of the inner cylinder 3. The inner cylinder 3 is disposed on a radially inner side of the outer cylinder 4. A central axis of the inner cylinder 3 and a central axis of the outer cylinder 4 coincide with each other. A reservoir chamber 6 is provided between the inner cylinder 3 and the outer cylinder 4.

The outer cylinder 4 has a barrel part 11 and a bottom part 12. The barrel part 11 and the bottom part 12 are integrally formed. The barrel part 11 has a cylindrical shape. The bottom part 12 closes a lower portion of the barrel part 11. A mounting eye (not illustrated) is fixed to the bottom part 12 on an outer side opposite to the barrel part 11 in an axial direction thereof.

The shock absorber 1 includes a piston 18. The piston 18 is inserted in the inner cylinder 3 of the cylinder 2. The piston 18 is slidably fitted in the inner cylinder 3 of the cylinder 2. The piston 18 partitions the inside of the inner cylinder 3 into two chambers, an upper chamber 19 on one side and a lower chamber 20 on the other side. In an axial direction of the cylinder 2, the upper chamber 19 is on a side opposite to the bottom part 12 with respect to the piston 18. The lower chamber 20 is on the bottom part 12 side with respect to the piston 18 in the axial direction of the cylinder 2. An oil fluid L is sealed in the upper chamber 19 and the lower chamber 20 in the inner cylinder 3 as a working fluid. In the reservoir chamber 6 between the inner cylinder 3 and the outer cylinder 4, the oil fluid L and a gas G are sealed as working fluids.

The shock absorber 1 includes a rod 21. A first end portion of the rod 21 on one end side in the axial direction is disposed inside the inner cylinder 3 of the cylinder 2. The first end portion of the rod 21 is fastened to the piston 18. A second end portion of the rod 21 on a side opposite to the first end portion in the axial direction protrudes from the cylinder 2 to the outside of the cylinder 2. The piston 18 is fixed to the rod 21. Therefore, the piston 18 and the rod 21 move together. In the shock absorber 1, a stroke in which the rod 21 moves in a direction to increase an amount of protrusion from the cylinder 2 is an extension stroke in which the entire length increases. In the shock absorber 1, a stroke in which the rod 21 moves in a direction to decrease an amount of protrusion from the cylinder 2 is a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 above the rod guide 22. The rod guide 22 and the seal member 23 are both annular. The rod 21 slides with respect to the rod guide 22 and the seal member 23 in the axial direction of them. The rod 21 extends from the inside of the cylinder 2 to the outside of the cylinder 2 with respect to the seal member 23.

The rod guide 22 restricts movement of the rod 21 in the radial direction with respect to the inner cylinder 3 and outer cylinder 4 of the cylinder 2. The rod 21 is fitted to the rod guide 22 and the piston 18 is fitted in the inner cylinder 3. Thereby, a central axis of the rod 21 and a central axis of the cylinder 2 coincide with each other. The rod guide 22 supports the rod 21 to be movable in an axial direction of the rod 21. An outer circumferential portion of the seal member 23 is in close contact with the outer cylinder 4. An inner circumferential portion of the seal member 23 is in close contact with an outer circumferential portion of the rod 21. The rod 21 moves in an axial direction of the seal member 23 with respect to the seal member 23. The seal member 23 curbs the oil fluid L in the inner cylinder 3, and the high-pressure gas G and the oil fluid L in the reservoir chamber 6 leaking to the outside.

An outer circumferential portion of the rod guide 22 has a larger diameter at an upper portion than at a lower portion. The rod guide 22 is fitted to an inner circumferential portion of an upper end of the inner cylinder 3 at the lower portion with a smaller diameter. The rod guide 22 is fitted to an upper inner circumferential portion of the outer cylinder 4 at the upper portion with a larger diameter. A base valve 25 is installed above the bottom part 12 of the outer cylinder 4. The base valve 25 is positioned in the radial direction with respect to the outer cylinder 4. An inner circumferential portion of a lower end of the inner cylinder 3 is fitted in the base valve 25.

An upper end portion of the outer cylinder 4 is swaged inward in the radial direction of the outer cylinder 4. The seal member 23 is fixed to the cylinder 2 by being sandwiched between the swaged portion and the rod guide 22.

The rod 21 includes a main shaft part 27 and a mounting shaft part 28. Both the main shaft part 27 and the mounting shaft part 28 have a rod shape.

The mounting shaft part 28 has an outer diameter smaller than an outer diameter of the main shaft part 27. The mounting shaft part 28 is disposed inside the cylinder 2. The piston 18 is attached to the mounting shaft part 28. The main shaft part 27 has a shaft step part 29. The shaft step part 29 is provided at an end portion of the main shaft part 27 on the mounting shaft part 28 side in the axial direction. The shaft step part 29 extends in a direction orthogonal to the central axis of the rod 21.

The rod 21 has a groove part 30 formed on an outer circumferential portion of the mounting shaft part 28. The groove part 30 extends in an axial direction of the mounting shaft part 28. The groove part 30 is formed by cutting out the outer circumferential portion of the mounting shaft part 28 into a planar shape parallel to a central axis of the mounting shaft part 28. The groove part 30 is formed at two locations spaced apart from each other in a circumferential direction of the mounting shaft part 28. A screw part 31 is formed on an outer circumferential portion of an end portion of the mounting shaft part 28 on a side opposite to the main shaft part 27 with respect to the groove part 30 in the axial direction of the mounting shaft part 28.

The shock absorber 1 is connected to a vehicle body of a vehicle, for example, with a portion of the rod 21 protruding from the cylinder 2 disposed at an upper portion. At that time, the shock absorber 1 is connected to a wheel side of the vehicle with the mounting eye (not illustrated) provided on the cylinder 2 side disposed at a lower portion. Conversely, the cylinder 2 side of the shock absorber 1 may be connected to the vehicle body. In this case, the rod 21 of the shock absorber 1 is connected to the wheel side.

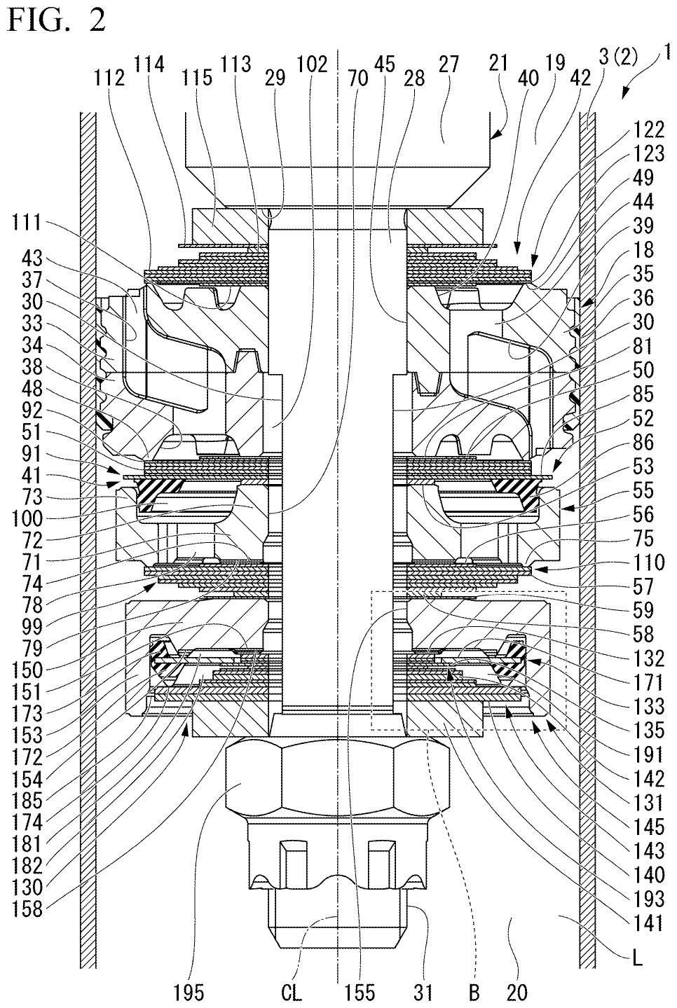

As illustrated in FIG. 2, the piston 18 includes a piston main body 35 and a slide member 36. The piston main body 35 is constituted by combining a segment body 33 and a segment body 34. The segment bodies 33 and 34 are both made of a metal, and both have an annular shape. In the segment bodies 33 and 34, an inner diameter of the segment body 33 is smaller than an inner diameter of the segment body 34. The slide member 36 is made of a synthetic resin and has an annular band shape. The slide member 36 is integrally attached to an outer circumferential surface of the piston main body 35 in which the segment body 33 and the segment body 34 are combined. Thereby, the segment bodies 33 and 34 and the slide member 36 are integrated to form the piston 18. The piston 18 is fitted onto the mounting shaft part 28 of the rod 21. The piston 18 slides with respect to the inner cylinder 3 with the slide member 36 in contact with the inner cylinder 3.

A passage hole 37, a passage groove 38, a passage hole 39, and a passage groove 40 are provided in the piston main body 35. The passage hole 37 extends in an axial direction of the piston main body 35. A plurality of passage holes 37 are formed in the piston main body 35 at intervals in a circumferential direction of the piston main body 35 (only one is illustrated in FIG. 2 because it is a cross section). The passage hole 39 extends in the axial direction of the piston main body 35. A plurality of passage holes 39 are formed in the piston main body 35 at intervals in the circumferential direction of the piston main body 35 (only one is illustrated in FIG. 2 because it is a cross section). In the piston main body 35, the passage holes 37 and the passage holes 39 are alternately formed one by one at a regular pitch in the circumferential direction of the piston main body 35.

The passage groove 38 is formed in the segment body 34 of the piston main body 35 in an annular shape in a circumferential direction of the segment body 34. The passage groove 38 is formed at an end portion of the segment body 34 on a side opposite to the segment body 33 in the axial direction. All the passage holes 37 open to the passage groove 38 at the end portion side in the axial direction of the piston main body 35. The passage groove 40 is formed in the segment body 33 of the piston main body 35 in an annular shape in a circumferential direction of the segment body 33. The passage groove 40 is formed at an end portion of the segment body 33 on a side opposite to the segment body 34 in the axial direction. All the passage holes 39 open to the passage groove 40 at the end portions on a side opposite to the passage groove 38 in the axial direction of the piston main body 35. In the piston 18, the inside of the plurality of passage holes 37 and the inside of the passage groove 38 form a first passage 43. The first passage 43 penetrates the piston 18 in an axial direction of the piston 18. In the piston 18, the inside of the plurality of passage holes 39 and the inside of the passage groove 40 form a first passage 44. The first passage 44 penetrates the piston 18 in the axial direction of the piston 18. The first passage 43 and the first passage 44 are both provided in the piston 18.

A first damping force generation mechanism 41 is disposed in the first passage 43. The first damping force generation mechanism 41 opens and closes the first passage 43 to generate a damping force. The first damping force generation mechanism 41 is disposed on the lower chamber 20 side which is one end side in the axial direction of the piston 18 to be attached to the rod 21. Thereby, the first passage 43 serves as a passage through which the oil fluid L as a working fluid moves from the upper chamber 19 toward the lower chamber 20 due to movement of the piston 18 to the upper chamber 19 side. That is, the first passage 43 is a passage through which the oil fluid L moves from the upper chamber 19 on an upstream side to the lower chamber 20 on a downstream side during the extension stroke. The first damping force generation mechanism 41 is an extension-side damping force generation mechanism that generates a damping force by suppressing a flow of the oil fluid L from the first passage 43 to the lower chamber 20 that occurs during the extension stroke.

A first damping force generation mechanism 42 is disposed in the first passage 44. The first damping force generation mechanism 42 opens and closes the first passage 44 to generate a damping force. The first damping force generation mechanism 42 is disposed on the upper chamber 19 side which is the other end side in the axial direction of the piston 18 to be attached to the rod 21. Thereby, the first passage 44 serves as a passage through which the oil fluid L moves from the lower chamber 20 toward the upper chamber 19 due to movement of the piston 18 to the lower chamber 20 side. That is, the first passage 44 is a passage through which the oil fluid L moves from the lower chamber 20 on an upstream side to the upper chamber 19 on a downstream side during the compression stroke. The first damping force generation mechanism 42 is a compression-side damping force generation mechanism that generates a damping force by suppressing a flow of the oil fluid L from the first passage 44 to the upper chamber 19 that occurs during the compression stroke.

The piston main body 35 has an insertion hole 45 formed at a center in the radial direction thereof to penetrate the piston main body 35 in the axial direction. The mounting shaft part 28 of the rod 21 is inserted through the insertion hole 45. The insertion hole 45 has a smaller diameter at a portion formed in the segment body 33 on the upper chamber 19 side in the axial direction than at a portion formed in the segment body 34 on the lower chamber 20 side. The piston main body 35 fits onto the mounting shaft part 28 of the rod 21 in the segment body 33 having a smaller inner diameter as described above.

A valve seat part 48 is formed at an end portion of the piston main body 35 on the lower chamber 20 side in the axial direction. The valve seat part 48 has an annular shape. The valve seat part 48 is disposed on an outer side with respect to an opening of the passage groove 38 on the lower chamber 20 side in the radial direction of the piston main body 35. The valve seat part 48 constitutes a part of the first damping force generation mechanism 41.

A valve seat part 49 is formed at an end portion of the piston main body 35 on the upper chamber 19 side in the axial direction. The valve seat part 49 has an annular shape. The valve seat part 49 is disposed on an outer side with respect to an opening of the passage groove 40 on the upper chamber 19 side in the radial direction of the piston main body 35. The valve seat part 49 constitutes a part of the first damping force generation mechanism 42.

In the piston main body 35, openings of all the passage holes 39 on the lower chamber 20 side are disposed on a side of the valve seat part 48 opposite to the passage groove 38 in the radial direction of the piston main body 35. In the piston main body 35, openings of all the passage holes 37 on the upper chamber 19 side are disposed on a side of the valve seat part 49 opposite to the passage groove 40 in the radial direction of the piston main body 35.

A plurality of (specifically, two) discs 50, a plurality of (specifically, five) discs 51, one pilot disc 52, one disc 53, one pilot case 55, one disc 56, a plurality of (specifically, six) discs 57, one disc 58, and one disc 59 are provided on the valve seat part 48 side in the axial direction of the piston 18 in order from the piston 18 side in the axial direction of the piston 18. The discs 50, 51, 53, 56 to 59, and the pilot case 55 are all made of a metal. All the discs 50, 51, 53, and 56 to 59 have a bored circular flat plate shape with a constant thickness. The mounting shaft part 28 of the rod 21 is fitted inside all the discs 50, 51, 53, and 56 to 59. Both the pilot disc 52 and the pilot case 55 have an annular shape. The mounting shaft part 28 of the rod 21 is fitted inside both the pilot disc 52 and the pilot case 55.

The pilot case 55 has a bottomed cylindrical shape. A through hole 70 is formed at a center of the pilot case 55 in the radial direction. The through hole 70 penetrates the pilot case 55 in an axial direction thereof. The pilot case 55 has a bottom part 71, an inner cylindrical part 72, an outer cylindrical part 73, an inner seat part 74, and a valve seat part 75.

The through hole 70 has a smaller diameter on the piston 18 side in the axial direction than on a side opposite to the piston 18, and the mounting shaft part 28 of the rod 21 is fitted in the small diameter part.

The bottom part 71 has a bored disc shape. A passage hole 78 penetrating the bottom part 71 in an axial direction of the bottom part 71 is formed in the bottom part 71 on a radially outer side of the through hole 70.

The inner cylindrical part 72 has a cylindrical shape and protrudes from an inner circumferential edge portion of the bottom part 71 to the piston 18 side in the axial direction of the bottom part 71.

The outer cylindrical part 73 has a cylindrical shape and protrudes from an outer circumferential edge portion of the bottom part 71 to the same side as the inner cylindrical part 72 in the axial direction of the bottom part 71.

The passage hole 78 is disposed between the inner cylindrical part 72 and the outer cylindrical part 73 in a radial direction of the bottom part 71.

The inner seat part 74 is annular and slightly protrudes from the inner circumferential edge portion of the bottom part 71 to a side opposite to the inner cylindrical part 72 in the axial direction. A passage groove 79 penetrating the inner seat part 74 in the radial direction is formed in the inner seat part 74.

The valve seat part 75 has an annular shape with a larger diameter than the inner seat part 74. The valve seat part 75 protrudes from the bottom part 71 to the same side as the inner seat part 74 in the axial direction of the bottom part 71 at an outer side of the inner seat part 74 in a radial direction of the inner seat part 74.

The passage hole 78 is disposed between the inner seat part 74 and the valve seat part 75 in the radial direction of the bottom part 71. A passage in the passage groove 79 of the inner seat part 74 is in constant communication with a passage in the groove part 30 of the rod 21 and a passage in the passage hole 78.

Of the plurality of discs 50, the disc 50 on the piston 18 side in the axial direction is in contact with a portion of the piston 18 on a radially inner side of the passage groove 38. A notch 81 is formed in the disc 50. A passage in the notch 81 is in constant communication with the first passage 43 of the piston 18 and the passage in the groove part 30 of the rod 21.

Of the plurality of discs 51, the disc 51 on a side closest to the piston 18 side in the axial direction is in contact with the valve seat part 48 of the piston 18. The plurality of discs 51 open and close an opening of the first passage 43 formed in the piston 18 by being separated from and coming into contact with the valve seat part 48.

The pilot disc 52 is formed of a disc 85 and a seal member 86.

The disc 85 is made of a metal and has a bored circular flat plate shape. The mounting shaft part 28 of the rod 21 is fitted inside the disc 85. Of the plurality of discs 51, the disc 51 on a side most opposite to the piston 18 in the axial direction is in contact with the disc 85 of the pilot disc 52.

The seal member 86 is made of rubber and is adhered to a side of the disc 85 opposite to the piston 18 in the axial direction. The seal member 86 is fixed to an outer circumferential side of the disc 85 and has an annular shape. The seal member 86 is fitted in a liquid-tight manner to an inner circumferential portion of the outer cylindrical part 73 of the pilot case 55 over the entire circumference. The seal member 86 is slidable in the axial direction with respect to the inner circumferential portion of the outer cylindrical part 73. The seal member 86 constantly seals a gap between the pilot disc 52 and the outer cylindrical part 73.

The plurality of discs 51 and the pilot disc 52 constitute a damping valve 91. When the damping valve 91 is separated from the valve seat part 48 of the piston 18 and opens, the oil fluid L from the first passage 43 is allowed to flow into the lower chamber 20 through between the piston 18 and the outer cylindrical part 73 of the pilot case 55. At that time, the damping valve 91 suppresses a flow of the oil fluid L between itself and the valve seat part 48. The damping valve 91 constitutes the extension-side first damping force generation mechanism 41. The damping valve 91 includes a fixed orifice 92 formed to allow the first passage 43 to communicate with the lower chamber 20 even when the plurality of discs 51 are in contact with the valve seat part 48. The fixed orifice 92 also constitutes the first damping force generation mechanism 41.

The disc 53 is in contact with the disc 85 of the pilot disc 52. The disc 53 is in contact with the inner cylindrical part 72 of the pilot case 55.

The disc 56 is in contact with the inner seat part 74 of the pilot case 55.

Of the plurality of discs 57, the disc 57 on the disc 56 side in the axial direction can be seated on the valve seat part 75. The plurality of discs 57 constitute a disc valve 99. The disc valve 99 can be separated from and seated on the valve seat part 75.

The disc 58 has an outer diameter smaller than a minimum outer diameter of the disc valve 99.

The disc 59 has an outer diameter larger than the outer diameter of the disc 58.

A space between the bottom part 71, the inner cylindrical part 72, and the outer cylindrical part 73 of the pilot case 55 and the pilot disc 52 and disc 53, a space between the bottom part 71, the inner seat part 74, and the valve seat part 75 of the pilot case 55 and the disc 56 and disc valve 99, and the inside of the passage hole 78 of the pilot case 55 serve as a back pressure chamber 100. The back pressure chamber 100 applies a pressure to the plurality of discs 51 in a direction of the piston 18 via the pilot disc 52. In other words, the back pressure chamber 100 applies an internal pressure to the damping valve 91 in a valve closing direction in which the damping valve 91 is seated on the valve seat part 48. The plurality of discs 51, the pilot disc 52, and the back pressure chamber 100 constitute a part of the first damping force generation mechanism 41. The back pressure chamber 100 is in constant communication with the passage in the groove part 30 of the rod 21 via the passage in the passage groove 79 of the pilot case 55.

The passage in the notch 81 of the disc 50, the passage in the groove part 30 of the rod 21, and the passage in the passage groove 79 of the pilot case 55 allow constant communication between the first passage 43 of the piston 18 and the back pressure chamber 100, thereby forming an introduction passage 102 that introduces the oil fluid L into the back pressure chamber 100 from the first passage 43. The extension-side first damping force generation mechanism 41 introduces some of the flow of the oil fluid L into the back pressure chamber 100 through the introduction passage 102, and controls an opening of the damping valve 91 using the pressure in the back pressure chamber 100.

The disc valve 99 allows the back pressure chamber 100 and the lower chamber 20 to communicate with each other by being separated from the valve seat part 75. At that time, the disc valve 99 suppresses a flow of oil fluid L between itself and the valve seat part 75.

The disc valve 99 and the valve seat part 75 constitute a second damping force generation mechanism 110. The second damping force generation mechanism 110 allows the back pressure chamber 100 and the lower chamber 20 to communicate with each other when the disc valve 99 is separated from the valve seat part 75. At that time, the second damping force generation mechanism 110 generates a damping force by suppressing a flow of the oil fluid L between the back pressure chamber 100 and the lower chamber 20. During the extension stroke, the second damping force generation mechanism 110 causes the oil fluid L to flow from the upper chamber 19 to the lower chamber 20 via the first passage 43, the introduction passage 102, and the back pressure chamber 100. The second damping force generation mechanism 110 serves as an extension-side damping force generation mechanism that generates a damping force by suppressing a flow of the oil fluid L from the back pressure chamber 100 to the lower chamber 20 that occurs during the extension stroke.

One disc 111, a plurality of (specifically, nine) discs 112, one disc 113, one disc 114, and one annular member 115 are provided on the valve seat part 49 side in the axial direction of the piston 18 in order from the piston 18 side in the axial direction of the piston 18. The discs 111 to 114 and the annular member 115 are all made of a metal. All the discs 111 to 114 and annular member 115 have a bored circular flat plate shape with a constant thickness. The mounting shaft part 28 of the rod 21 is fitted inside all the discs 111 to 114 and the annular member 115.

The disc 111 is in contact with a portion of the piston 18 on a radially inner side of the passage groove 40.

Of the plurality of discs 112, the disc 112 closest to the piston 18 side in the axial direction is in contact with the valve seat part 49 of the piston 18. The plurality of discs 112 open and close an opening of the first passage 44 formed in the piston 18 by being separated from and coming into contact with the valve seat part 49.

The plurality of discs 112 constitute a disc valve 122. The disc valve 122 can be separated from and seated on the valve seat part 49. The disc valve 122 can open the first passage 44 to the upper chamber 19 by being separated from the valve seat part 49. When the disc valve 122 opens by being separated from the valve seat part 49 of the piston 18, the oil fluid L from the first passage 44 is allowed to flow into the upper chamber 19. At that time, the disc valve 122 suppresses a flow of the oil fluid L between itself and the valve seat part 49. Therefore, the disc valve 122 suppresses a flow of the oil fluid L from the lower chamber 20 to the upper chamber 19 through the first passage 44. The disc valve 122 and the valve seat part 49 constitute the compression-side first damping force generation mechanism 42. The disc valve 122 includes a fixed orifice 123 formed to allow the first passage 44 to communicate with the upper chamber 19 even when the disc valve 122 is in contact with the valve seat part 49. The fixed orifice 123 also constitutes the first damping force generation mechanism 42.

The disc 113 has an outer diameter smaller than a minimum outer diameter of the disc valve 122.

The disc 114 has an outer diameter larger than the outer diameter of the disc 113. The disc 114 and the annular member 115 come into contact with the disc valve 122 when the disc valve 122 is deformed in an opening direction to suppress deformation of the disc valve 122 in the opening direction beyond a specified limit. The annular member 115 is in contact with the shaft step part 29 of the rod 21.

A frequency sensitive mechanism 130 is provided on a side of the disc 59 opposite to the disc 58 in the axial direction. The frequency sensitive mechanism 130 makes a damping force variable according to a frequency of axial movement of the piston 18 (hereinafter referred to as a piston frequency).

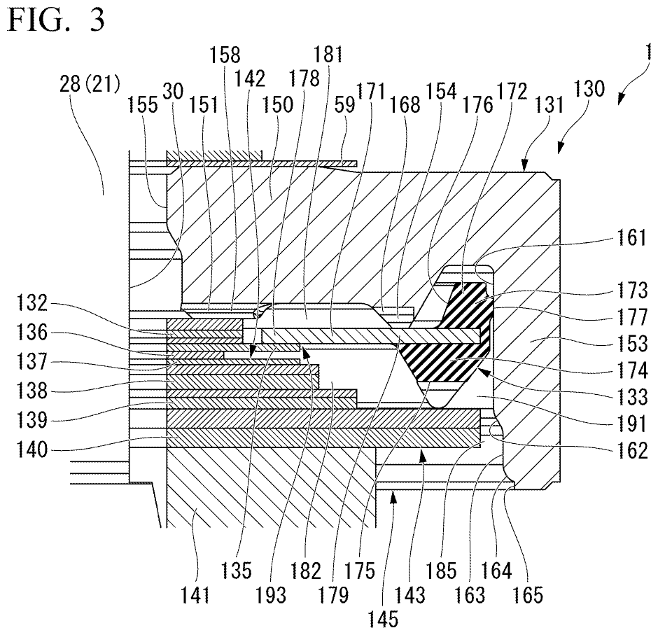

As illustrated in FIG. 3, the frequency sensitive mechanism 130 includes one case member 131 on the disc 59 side in the axial direction. The frequency sensitive mechanism 130 includes a plurality of (specifically, three) discs 132 having the same outer diameter and the same inner diameter, and one valve member 133 (first valve) on a side of the case member 131 opposite to the disc 59 in the axial direction. The frequency sensitive mechanism 130 includes one flexible member 135 (plate-shaped member), one disc 136, one stopper disc 137, a plurality of (specifically, two) stopper discs 138 with the same outer diameter and the same inner diameter, a plurality of (specifically, two) stopper discs 139 with the same outer diameter and the same inner diameter, and a plurality of (specifically, two) discs 140 with the same outer diameter and the same inner diameter on a side of the disc 132 and the valve member 133 opposite to the disc 59 in the axial direction in order from the disc 132 and the valve member 133 side. An annular member 141 is provided on a side of the discs 140 opposite to the stopper discs 139 in the axial direction. The stopper disc 137, the plurality of stopper discs 138, and the plurality of stopper discs 139 constitute a stopper 142. The plurality of discs 140 constitute a support member 143.

The case member 131, the discs 132, 136, and 140, the flexible member 135, the stopper discs 137 to 139, and the annular member 141 are all made of a metal. All the discs 132, 136, and 140, flexible member 135, stopper discs 137 to 139, and annular member 141 have a bored circular flat plate shape with a constant thickness. In other words, the discs 132, 136, and 140, the flexible member 135, the stopper discs 137 to 139, and the annular member 141 are each formed of a annular plate-shaped member. The discs 132, 136, and 140, the valve member 133, the flexible member 135, the stopper discs 137 to 139, and the annular member 141 are all disposed on an inner side of the case member 131 in the radial direction. The mounting shaft part 28 of the rod 21 is fitted inside all the case member 131, the discs 132, 136, and 140, the flexible member 135, the stopper discs 137 to 139, and the annular member 141. Thereby, the case member 131, the discs 132, 136, and 140, the flexible member 135, the stopper discs 137 to 139, and the annular member 141 are all made to coincide with the rod 21 in central axis. The mounting shaft part 28 of the rod 21 and the plurality of discs 132 are inserted through an inner circumferential side of the valve member 133 with a gap in the radial direction. In the frequency sensitive mechanism 130, the case member 131, the discs 132, 136, and 140, the flexible member 135, and the stopper discs 137 to 139 constitute a valve case 145. The frequency sensitive mechanism 130 includes the valve member 133 inside the valve case 145.

The case member 131 has a bottomed cylindrical shape.

A through hole 155 penetrating the case member 131 in the axial direction is formed at a center of the case member 131 in the radial direction. As illustrated in FIG. 2, the through hole 155 has a smaller diameter on the piston 18 side in the axial direction than on a side opposite to the piston 18, and the mounting shaft part 28 of the rod 21 is fitted in the small diameter part.

As illustrated in FIG. 3, the case member 131 includes a bottom part 150, a protruding part 151, a cylindrical part 153, and a seat part 154.

The bottom part 150 has a bored disc shape. The bottom part 150 has a constant radial width over the entire circumference. The through hole 155 is formed in the bottom part 150.

The protruding part 151 has an annular shape. The protruding part 151 protrudes from an inner circumferential edge portion of the bottom part 150 to a side of the bottom part 150 opposite to the disc 59 in the axial direction. A passage groove 158 penetrating the protruding part 151 in the radial direction is formed in the protruding part 151. A passage in the passage groove 158 communicates with the passage in the groove part 30 of the rod 21.

The cylindrical part 153 has a cylindrical shape with an inner diameter larger than an outer diameter of the protruding part 151. The cylindrical part 153 extends from an outer circumferential edge portion of the bottom part 150 to the same side as the protruding part 151 in an axial direction of the bottom part 150. The cylindrical part 153 includes a small diameter part 161, a first inclined part 162, a large diameter part 163, a second inclined part 164, and an opening end part 165 on an inner circumferential side in order from the bottom part 150 side in the axial direction. The small diameter part 161, the first inclined part 162, the large diameter part 163, the second inclined part 164, and the opening end part 165 are made to coincide with each other in central axis.

The small diameter part 161 is on the bottom part 150 side in an axial direction of the cylindrical part 153. An inner circumferential surface of the small diameter part 161 has a cylindrical surface shape.

The first inclined part 162 extends in a direction opposite to the bottom part 150 from an end portion of the small diameter part 161 on a side opposite to the bottom part 150 in the axial direction. The first inclined part 162 has an inner circumferential surface whose inner diameter increases toward a side opposite to the bottom part 150 in the axial direction of the cylindrical part 153. In other words, the first inclined part 162 extends in the axial direction of the cylindrical part 153 while increasing a diameter thereof toward a side opposite to the bottom part 150. The first inclined part 162 has a tapered shape.

The large diameter part 163 extends in a direction opposite to the bottom part 150 from an end portion of the first inclined part 162 on a side opposite to the bottom part 150 in the axial direction. An inner circumferential surface of the large diameter part 163 has a cylindrical surface shape. The large diameter part 163 is formed to have a larger inner diameter than the small diameter part 161. An axial length of the large diameter part 163 is smaller than an axial length of the small diameter part 161. The first inclined part 162 is provided between the small diameter part 161 and the large diameter part 163 in the axial direction of the cylindrical part 153.

The second inclined part 164 extends in a direction opposite to the bottom part 150 from an end portion of the large diameter part 163 on a side opposite to the bottom part 150 in the axial direction. The second inclined part 164 has an inner circumferential surface whose inner diameter increases toward a side opposite to the bottom part 150 in the axial direction of the cylindrical part 153. In other words, the second inclined part 164 extends in the axial direction of the cylindrical part 153 while increasing a diameter thereof toward a side opposite to the bottom part 150. In yet other words, the second inclined part 164 is inclined to have a smaller inner diameter toward the bottom part 150 side in the axial direction of the cylindrical part 153. The second inclined part 164 is on a side of the large diameter part 163 opposite to the bottom part 150 in the axial direction of the cylindrical part 153. The second inclined part 164 has an R-chamfered shape.

The opening end part 165 extends in a direction opposite to the bottom part 150 from an end portion of the second inclined part 164 on a side opposite to the bottom part 150 in the axial direction. The opening end part 165 is an end portion of the cylindrical part 153 on a side opposite to the bottom part 150 in the axial direction. An inner circumferential surface of the opening end part 165 has a cylindrical surface shape. The opening end part 165 is formed to have a larger inner diameter than the large diameter part 163. An axial length of the opening end part 165 is smaller than the axial length of the large diameter part 163.

As described above, the cylindrical part 153 includes the small diameter part 161 extending from the bottom part 150 and formed on the bottom part 150 side to have a small inner diameter, and the large diameter part 163 disposed on a side opposite to the bottom part 150 with respect to the small diameter part 161 and formed to have a larger inner diameter than the small diameter part 161. Also, the cylindrical part 153 includes the first inclined part 162 inclined to connect the small diameter part 161 and the large diameter part 163 between the small diameter part 161 and the large diameter part 163. Also, the cylindrical part 153 includes the second inclined part 164 inclined to have a smaller inner diameter toward the bottom part 150 side on a side opposite to the bottom part 150 with respect to the large diameter part 163.

The disc 132 has a constant outer diameter over the entire circumference and a constant radial width over the entire circumference. The outer diameter of the disc 132 is slightly smaller than an outer diameter of an end surface of the protruding part 151 on a side opposite to the bottom part 150 in the axial direction.

The flexible member 135 has a constant outer diameter over the entire circumference and a constant radial width over the entire circumference. The flexible member 135 has an outer diameter larger than the outer diameter of the disc 132.

The disc 136 has a constant outer diameter over the entire circumference and a constant radial width over the entire circumference. The outer diameter of the disc 136 is smaller than the outer diameter of the flexible member 135 and smaller than the outer diameter of the disc 132.

The stopper disc 137 has a constant outer diameter over the entire circumference and a constant radial width over the entire circumference. The outer diameter of the stopper disc 137 is larger than the outer diameter of the disc 136 and is equal to the outer diameter of the flexible member 135.

The stopper disc 138 has a constant outer diameter over the entire circumference and a constant radial width over the entire circumference. The outer diameter of the stopper disc 138 is larger than the outer diameter of the stopper disc 137.

The stopper disc 139 has a constant outer diameter over the entire circumference and a constant radial width over the entire circumference. The outer diameter of the stopper disc 139 is larger than the outer diameter of the stopper disc 138.

The stopper 142 is constituted by the stopper discs 137 to 139 as described above. In other words, the stopper 142 includes the plurality of stopper discs 137 to 139 which are all formed of an annular plate-shaped member. In the axial direction of the case member 131, the stopper discs 137 and 138 are formed such that the outer diameter of the stopper disc 138 provided on a side opposite to the flexible member 135 is larger than the outer diameter of the stopper disc 137 provided on the flexible member 135 side. In the axial direction of the case member 131, the stopper discs 138 and 139 are formed such that the outer diameter of the stopper disc 139 provided on a side opposite to the flexible member 135 is larger than the outer diameter of the stopper disc 138 provided on the flexible member 135 side.

The disc 140 constituting the support member 143 has a constant outer diameter over the entire circumference and a constant radial width over the entire circumference. The outer diameter of the disc 140 is larger than the outer diameter of the stopper disc 139.

The discs 132, 136, and 140, the valve member 133, the flexible member 135, the stopper discs 137 to 139, and the annular member 141 are all disposed inside the cylindrical part 153 in the radial direction. In other words, outer diameters of the discs 132, 136, and 140, the valve member 133, the flexible member 135, the stopper discs 137 to 139, and the annular member 141 are each smaller than an inner diameter of the cylindrical part 153 at a portion overlapping each of them in position in the axial direction. The discs 132, 136, and 140, the valve member 133, the flexible member 135, and stopper discs 137 to 139 are all disposed within a range of the cylindrical part 153 in the axial direction of cylindrical part 153. A part of the annular member 141 is disposed within the range of the cylindrical part 153 in the axial direction of the cylindrical part 153, and a remaining part thereof is disposed outside the range of the cylindrical part 153 in the axial direction of the cylindrical part 153.

The discs 132 and 136, the stopper discs 137 to 139, and the flexible member 135 are disposed within a range of the small diameter part 161 in the axial direction of the cylindrical part 153. The discs 132 and 136, the stopper discs 137 to 139, and the flexible member 135 each have an outer diameter smaller than an inner diameter of the small diameter part 161.

The support member 143 formed of the plurality of discs 140 overlaps the small diameter part 161, the first inclined part 162, and the large diameter part 163 in position in the axial direction of the cylindrical part 153. The discs 140, that is, the support member 143 have an outer diameter smaller than the inner diameter of the small diameter part 161. In the axial direction of the cylindrical part 153, the first inclined part 162 is provided within a range of the support member 143 over the entire length.

The annular member 141 overlaps the large diameter part 163, the second inclined part 164, and the opening end part 165 in position in the axial direction of the cylindrical part 153. The annular member 141 has an outer diameter smaller than an inner diameter of the large diameter part 163. In the axial direction of the cylindrical part 153, the second inclined part 164 and the opening end part 165 are provided within a range of the annular member 141 over the entire length.

The seat part 154 has an annular shape. The seat part 154 protrudes from a position between the protruding part 151 and the cylindrical part 153 in a radial direction of the bottom part 150 to the same side as the protruding part 151 and the cylindrical part 153 in the axial direction of the bottom part 150. The seat part 154 has a notch part 168 formed at a distal end portion on a protruding side to penetrate the distal end portion in a radial direction of the seat part 154. A plurality of notch parts 168 are formed in the seat part 154 at intervals in a circumferential direction of the seat part 154. Therefore, the distal end portion on the protruding side of the seat part 154 is intermittently cut out in the circumferential direction of the seat part 154. In the axial direction of the bottom part 150, a protruding height of the seat part 154 from the bottom part 150 is larger than a protruding height of the protruding part 151 from the bottom part 150.

The valve member 133 is formed of a valve disc 171 and an elastic seal member 172. The valve member 133 is disposed at a position between the cylindrical part 153 of the case member 131 and the plurality of discs 132 in the radial direction.

The valve disc 171 is made of a metal. The valve disc 171 has a bored circular flat plate shape with a constant thickness. The valve disc 171 has a constant outer diameter over the entire circumference and a constant radial width over the entire circumference. The mounting shaft part 28 of the rod 21 and the plurality of discs 132 are inserted through an inner circumferential side of the valve disc 171. The valve disc 171 is elastically deformable, that is, bendable. The valve disc 171 has an inner diameter that allows the plurality of discs 132 to be disposed inside with a gap in the radial direction. That is, the inner diameter of the valve disc 171 is larger than the outer diameter of the plurality of discs 132. The outer diameter of the valve disc 171 is smaller than the inner diameter of the small diameter part 161 of the cylindrical part 153. The valve disc 171 has a smaller thickness than a total thickness of all the discs 132.

The elastic seal member 172 is made of rubber and has an annular shape. The elastic seal member 172 is adhered to an outer circumferential side of the valve disc 171. The elastic seal member 172 is provided integrally with the valve disc 171 by being baked into the valve disc 171.

The elastic seal member 172 includes a seal part 173 and a biasing part 174.

The seal part 173 has an annular shape and is fixed to the outer circumferential side of the valve disc 171 over the entire circumference. The seal part 173 protrudes from the valve disc 171 to the bottom part 150 side of the case member 131 in the axial direction of the valve member 133.

The biasing part 174 has an annular shape and protrudes from the valve disc 171 to a side opposite to the bottom part 150 in the axial direction of the valve member 133. The biasing part 174 is fixed to the outer circumferential side of the valve disc 171. On the outer circumferential side of the valve disc 171, the seal part 173 and the biasing part 174 are connected and integrated. An outer diameter of the biasing part 174 decreases and an inner diameter thereof increases with distance away from the valve disc 171 in the axial direction. Thereby, a cross-sectional shape of the biasing part 174 in a plane including a central axis thereof is a tapered single chevron shape that becomes thinner with distance away from the valve disc 171 in the axial direction. The biasing part 174 has a notch part 175 formed at a distal end portion on the protruding side to penetrate the distal end portion in a radial direction of the biasing part 174. A plurality of notch parts 175 are formed in the biasing part 174 at intervals in a circumferential direction of the biasing part 174. Therefore, in the biasing part 174, the distal end portion on the protruding side is intermittently cut out in the circumferential direction of the biasing part 174.

As described above, there is a radial gap between the valve member 133 and the plurality of discs 132. Then, the valve member 133 is press-fitted into the small diameter part 161 of the cylindrical part 153 of the case member 131 at the seal part 173 thereof. Due to this press fitting, the valve member 133 is centered to be disposed coaxially with the case member 131, the plurality of discs 132, and the rod 21. At that time, the seal part 173 of the valve member 133 is in contact with the small diameter part 161 over the entire circumference with a fastening allowance in the radial direction.

The seal part 173 includes a cylindrical base part 176 and an annular projecting part 177. The seal part 173 is adhered to the valve disc 171 and is connected to the biasing part 174 at the base part 176. The projecting part 177 protrudes outward in a radial direction of the base part 176 from an intermediate position of the base part 176 in the axial direction. When the elastic seal member 172 is in a natural state without being deformed in its entirety including the projecting part 177, an outer diameter of the base part 176 is smaller than the inner diameter of the small diameter part 161. Also, when the elastic seal member 172 is in a natural state in its entirety, an outer diameter of the projecting part 177 is larger than the inner diameter of the small diameter part 161 and smaller than the inner diameter of the large diameter part 163.

The valve member 133 is press-fitted into the small diameter part 161 of the cylindrical part 153 of the case member 131 at the seal part 173 thereof. Then, in the seal part 173, mainly the projecting part 177 elastically deforms inward in the radial direction to be in close contact with the small diameter part 161 over the entire circumference. Thereby, the seal part 173 fits into the small diameter part 161 of the cylindrical part 153 of the case member 131 in a liquid-tight manner over the entire circumference.

The seal part 173 is slidable with respect to the cylindrical part 153 in the axial direction of the cylindrical part 153. At that time, the seal part 173 slides in the axial direction of the cylindrical part 153 with respect to the small diameter part 161 while maintaining a state in which the projecting part 177 is in close contact with the small diameter part 161 over the entire circumference. Thereby, in the elastic seal member 172, the projecting part 177 of the seal part 173 constantly seals a gap between the valve member 133 and the cylindrical part 153. The small diameter part 161 is provided in the cylindrical part 153 in a sliding range of the projecting part 177 of the valve member 133. Then, in addition to the small diameter part 161 which is the sliding range of the projecting part 177, the first inclined part 162, the large diameter part 163, the second inclined part 164, and the opening end part 165, which serve as a guide section for assembling the valve member 133, are provided in the cylindrical part 153. Of these, the large diameter part 163, the second inclined part 164, and the opening end part 165 all have an inner diameter larger than the outer diameter of the projecting part 177 of the valve member 133 in a natural state. The seal part 173 is on a radially outer side of the seat part 154 of the case member 131. The valve disc 171 of the valve member 133 is seated on the seat part 154.

The flexible member 135 has an outer diameter larger than an inner diameter of the valve member 133, that is, the inner diameter of the valve disc 171. The flexible member 135 is disposed on a side of the valve disc 171 opposite to the bottom part 150 in the axial direction and presses against a first support part 178 on an inner circumferential side of the valve disc 171 over the entire circumference. Thereby, a gap between the flexible member 135 and the valve disc 171, that is, the valve member 133, is closed.

When the seal part 173 is in contact with the cylindrical part 153 over the entire circumference as described above, the valve member 133 is centered with respect to the valve case 145.

In this state, in the valve member 133, the first support part 178 on the inner circumferential side of the valve disc 171 is disposed between the protruding part 151 and the flexible member 135 in the axial direction. Then, the first support part 178 is supported by the flexible member 135 with one surface on a side opposite to the bottom part 150 in the axial direction in contact with the flexible member 135. In other words, the valve member 133 includes the first support part 178 in which one surface on the radially inner side is supported by the flexible member 135. The first support part 178 is supported by the flexible member 135 on only one side without being clamped from both sides. In the valve member 133, the first support part 178 on the inner circumferential side of the valve disc 171 is movable in a range of an entire axial length of the plurality of (specifically, three) discs 132 between the protruding part 151 and the flexible member 135.

The valve member 133 is supported by the seat part 154 with a second support part 179 of the valve disc 171, which is disposed on a radially outer side of the first support part 178, in contact with the seat part 154 on one surface on the bottom part 150 side in the axial direction. In other words, the valve member 133 includes the second support part 179 disposed on a radially outer side of the first support part 178 and having one surface supported by the seat part 154. The second support part 179 is supported by the seat part 154 on only one side without being clamped from both sides.

Therefore, the valve member 133 has a simple support structure in which one side of the first support part 178 of the valve disc 171 is supported by the flexible member 135, and the other side of the second support part 179 of the valve disc 171, which is on a radially outer side of the first support part 178, is supported by the seat part 154. In other words, the valve disc 171 is not clamped in the axial direction.

In the valve member 133, the biasing part 174 is disposed on a side of the valve member 133 opposite to the bottom part 150 in the axial direction. A part of the biasing part 174 is disposed on an outer side of the second support part 179 in a radial direction of the valve member 133. The biasing part 174 is in contact with the support member 143 formed of the plurality of discs 140 at a portion disposed on a radially outer side of the second support part 179. The biasing part 174 biases the second support part 179 side in the radial direction of the valve member 133 to the seat part 154 side in the axial direction of the valve member 133. The entire biasing part 174 may be disposed on a radially outer side with respect to the second support part 179. That is, in the valve member 133, at least a part of the biasing part 174 need only be disposed on a radially outer side with respect to the second support part 179.

The valve member 133 has an annular plate shape as a whole and is elastically deformable, that is, bendable as a whole. The valve member 133 is bendable such that the second support part 179 is separated from the seat part 154 while the first support part 178 remains in contact with the flexible member 135. When bending in this manner, the valve member 133 is bent to move the second support part 179 to a side opposite to the bottom part 150 in the axial direction of the case member 131 with respect to the first support part 178.

The flexible member 135 has an outer diameter larger than the outer diameter of the disc 136 that is in contact with a surface of the flexible member 135 on a side opposite to the first support part 178 in the axial direction. Therefore, the flexible member 135 is bendable in a direction away from the bottom part 150 in the axial direction of the case member 131.

The valve member 133 is bendable such that the second support part 179 is separated from the seat part 154 while the first support part 178 remains in contact with the flexible member 135.

The flexible member 135 is bendable together with the valve member 133. The flexible member 135 has a thickness smaller than a thickness of the valve disc 171 of the valve member 133, and has a lower rigidity than the valve disc 171, thereby more likely to be bent. The flexible member 135 is bent in a direction opposite to the bottom part 150 due to movement and deformation of the valve member 133 to a side opposite to the seat part 154 in the axial direction. The stopper 142 formed of the stopper discs 137 to 139 suppresses an amount of bending of the flexible member 135 with the stopper disc 137 coming into contact with the flexible member 135 that bends in that manner. Here, even if bending of the flexible member 135 is suppressed by the stopper 142, the valve member 133 is bendable to move the second support part 179 further to a side opposite to the bottom part 150 in the axial direction of the case member 131 with respect to the first support part 178.

The plurality of discs 140 have an outer diameter larger than the outer diameter of the stopper disc 139 and smaller than the inner diameter of the cylindrical part 153. The support member 143 formed of the plurality of discs 140 is in contact with the stopper disc 139 and the annular member 141 on an inner circumferential side thereof, and comes into contact with the biasing part 174 of the valve member 133 on an outer circumferential side thereof. The support member 143 suppresses movement of the valve member 133 in a direction opposite to the bottom part 150 in the axial direction.

The seat part 154 of the case member 131 supports the second support part 179 of the valve disc 171 of the valve member 133 from one side in the axial direction. The flexible member 135 supports the first support part 178 of the valve disc 171 on an inner circumferential side with respect to the seat part 154 from the other side in the axial direction. A shortest distance in the axial direction between the seat part 154 and the flexible member 135 is slightly smaller than a thickness of the valve disc 171 in the axial direction. Therefore, the valve disc 171 presses against both the seat part 154 and the flexible member 135 with its own elastic force in a state of being slightly elastically deformed.

The valve member 133 is provided inside the case member 131 and partitions the inside of the case member 131 into a first chamber 181 and a second chamber 182. The first chamber 181 is between the bottom part 150 and the valve member 133 in the axial direction of the case member 131. In other words, the first chamber 181 is on the bottom part 150 side with respect to the valve member 133 in the axial direction of the case member 131. The second chamber 182 is between the valve member 133 and the support member 143 in the axial direction of the case member 131. The support member 143 is provided in the second chamber 182 to form the second chamber 182. The second chamber 182 is on a side opposite to the bottom part 150 with respect to the valve member 133 in the axial direction of the case member 131, that is, on an opening side of the case member 131.

Both the first chamber 181 and the second chamber 182 are variable in capacity, and capacities thereof change due to movement and deformation of the valve member 133. The first chamber 181 is in constant communication with the passage in the groove part 30 of the rod 21 via the passage in the passage groove 158 of the case member 131. The first chamber 181 is in constant communication with the upper chamber 19 via the passage in the passage groove 158, the passage in the groove part 30, the passage in the notch 81 illustrated in FIG. 2, and the first passage 43. Also, the first chamber 181 is in constant communication with the back pressure chamber 100 via the passage in the passage groove 158 illustrated in FIG. 3, the passage in the groove part 30, and the passage in the passage groove 79 illustrated in FIG. 2. The second chamber 182 is in constant communication with the lower chamber 20 via a passage part 185 between the support member 143 and the cylindrical part 153 of the case member 131.

During the extension stroke, the oil fluid L from the upper chamber 19 illustrated in FIG. 2 is introduced into the first chamber 181 via the first passage 43, the passage in the notch 81 of the disc 50, the passage in the groove part 30 of the rod 21, and the passage in the passage groove 158 of the case member 131 illustrated in FIG. 3. Then, the valve disc 171 of the valve member 133 bends the flexible member 135, that is in contact therewith at the first support part 178, in a direction away from the bottom part 150 in the axial direction of the case member 131, that is, in a direction of the stopper disc 137. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135 as a fulcrum. In this way, the valve disc 171 is bent so that the second support part 179 is separated from the bottom part 150 in the axial direction of the case member 131 with respect to the first support part 178 using a contact point with the flexible member 135 as a fulcrum while moving away from the bottom part 150 in the axial direction of the case member 131.

As the introduction of the oil fluid L into the first chamber 181 further progresses, the flexible member 135 in contact with the valve disc 171 comes into contact with the stopper disc 137 of the stopper 142, and thereby bending is restricted. Then, the valve disc 171 is bent in a tapered shape so that the second support part 179 is further separated from the bottom part 150 in the axial direction of the case member 131 with respect to the first support part 178 using a contact point with the flexible member 135 as a fulcrum while further compressively deforming the biasing part 174 in the axial direction of the case member 131 between the valve disc 171 and the support member 143.

Due to the movement and deformation of the valve disc 171 as described above, the valve member 133 increases a volume of the first chamber 181. Here, during this deformation of the valve disc 171, a volume of the second chamber 182 decreases. At that time, the oil fluid L in the second chamber 182 flows into the lower chamber 20 via the passage part 185.

As illustrated in FIG. 2, the first passage 43, the passage in the notch 81, the passage in the groove part 30 of the rod 21, the passage in the passage groove 158, the first chamber 181, the second chamber 182, and the passage part 185 constitute a second passage 191 (passage). In the second passage 191, the first passage 43, the passage in the notch 81, the passage in the groove part 30, the passage in the passage groove 158, and the first chamber 181 are in constant communication with the upper chamber 19. In the second passage 191, the passage part 185 and the second chamber 182 are in constant communication with the lower chamber 20. The second passage 191 is a passage through which the oil fluid L moves from the upper chamber 19 on an upstream side to the lower chamber 20 on a downstream side during the extension stroke. The second passage 191 is a passage through which the oil fluid L moves from the lower chamber 20 on an upstream side to the upper chamber 19 on a downstream side during the compression stroke. The valve member 133 of the frequency sensitive mechanism 130 is provided in the second passage 191.

In the valve member 133, the first support part 178, illustrated in FIG. 3, on the inner circumferential side of the valve disc 171 is movable to the bottom part 150 side in the axial direction between the case member 131 and the flexible member 135. Also, in the valve member 133, the first support part 178 of the valve disc 171 is movable to a side opposite to the bottom part 150 in the axial direction while bending the flexible member 135 until bending of the flexible member 135 is suppressed by the stopper 142. In a state in which the first support part 178 of the valve disc 171 is in contact with the flexible member 135 over the entire circumference, the valve member 133 blocks a flow of the oil fluid L between the first chamber 181 and the second chamber 182. Also, in a state in which the first support part 178 of the valve disc 171 is separated from the flexible member 135 in the axial direction, the valve member 133 allows a flow of the oil fluid L between the second chamber 182 and the first chamber 181. The first support part 178 of the valve disc 171 and the flexible member 135 constitute a check valve 193. The check valve 193 is provided in the second passage 191.

The check valve 193 restricts a flow of the oil fluid L from the first chamber 181 to the second chamber 182 through the second passage 191 while allowing a flow of the oil fluid L from the second chamber 182 to the first chamber 181 through the second passage 191. The check valve 193 blocks communication between the upper chamber 19 and the lower chamber 20 through the second passage 191 during the extension stroke in which a pressure in the upper chamber 19 is higher than a pressure in the lower chamber 20. The check valve 193 allows communication between the lower chamber 20 and the upper chamber 19 through the second passage 191 during the compression stroke in which a pressure in the lower chamber 20 is higher than a pressure in the upper chamber 19. In this way, the second passage 191 allows communication between the lower chamber 20 and the upper chamber 19 when the check valve 193 opens.

On the rod 21, as illustrated in FIG. 2, the annular member 115, the disc 114, the disc 113, the plurality of discs 112, the disc 111, the piston 18, the plurality of discs 50, the plurality of discs 51, the pilot disc 52, the disc 53, the pilot case 55, the disc 56, the plurality of discs 57, the disc 58, the disc 59, the case member 131, and the plurality of discs 132 are stacked in that order on the shaft step part 29 with the mounting shaft part 28 inserted through the inside of them. At that time, the pilot case 55 fits the seal member 86 of the pilot disc 52 into the outer cylindrical part 73.

Also, from this state, the valve member 133 is stacked on the seat part 154 of the case member 131 with the mounting shaft part 28 and the plurality of discs 132 inserted through the inside as illustrated in FIG. 3. At this time, the elastic seal member 172 of the valve member 133 is fitted into the cylindrical part 153 of the case member 131.

Further, the flexible member 135, the disc 136, the stopper disc 137, the plurality of stopper discs 138, the plurality of stopper discs 139, the plurality of discs 140, and the annular member 141 are stacked in that order on the disc 132 and the valve disc 171 of the valve member 133 with the mounting shaft part 28 inserted through the inside of them.

As illustrated in FIG. 2, with the parts from the annular member 115 to the annular member 141 disposed on the rod 21 as described above, a nut 195 is screwed onto the screw part 31 of the mounting shaft part 28 that protrudes from the annular member 141. Thereby, the parts from the annular member 115 to the annular member 141 are clamped in the axial direction by the shaft step part 29 of the rod 21 and the nut 195 at the inner circumferential side of them or in their entirety. At that time, the valve member 133, also including the inner circumferential side, is not clamped in the axial direction. In this state, in the valve member 133, as illustrated in FIG. 3, the first support part 178 of the valve disc 171 is in contact with the flexible member 135, the second support part 179 is in contact with the seat part 154 of the case member 131, and the biasing part 174 of the elastic seal member 172 is in contact with the support member 143

As illustrated in FIG. 1, the base valve 25 described above is provided between the bottom part 12 of the outer cylinder 4 and the inner cylinder 3. The base valve 25 includes a base valve member 221, a disc valve 222, a disc valve 223, and an attachment pin 224. In the base valve 25, the base valve member 221 is placed on the bottom part 12, and the base valve member 221 is fitted in the inner cylinder 3. The base valve member 221 partitions the lower chamber 20 and the reservoir chamber 6. The disc valve 222 is provided on a lower side of the base valve member 221, that is, on the reservoir chamber 6 side. The disc valve 223 is provided on an upper side of the base valve member 221, that is, on the lower chamber 20 side. The attachment pin 224 attaches the disc valve 222 and the disc valve 223 to the base valve member 221.

The base valve member 221 has an annular shape, and the attachment pin 224 is inserted through a center thereof in the radial direction. A plurality of passage holes 225 and a plurality of passage holes 226 are formed in the base valve member 221. The plurality of passage holes 225 allow the oil fluid L to flow between the lower chamber 20 and the reservoir chamber 6. The plurality of passage holes 226 are disposed on an outer side of the plurality of passage holes 225 in a radial direction of the base valve member 221. The plurality of passage holes 226 allow the oil fluid L to flow between the lower chamber 20 and the reservoir chamber 6. The disc valve 222 on the reservoir chamber 6 side allows the oil fluid L to flow from the lower chamber 20 to the reservoir chamber 6 through the passage holes 225. On the other hand, the disc valve 222 suppresses a flow of the oil fluid L from the reservoir chamber 6 to the lower chamber 20 through the passage holes 225. The disc valve 223 allows the oil fluid L to flow from the reservoir chamber 6 to the lower chamber 20 through the passage holes 226. On the other hand, the disc valve 223 suppresses a flow of the oil fluid L from the lower chamber 20 to the reservoir chamber 6 through the passage holes 226.

The disc valve 222, together with the base valve member 221, constitutes a damping valve mechanism 227. The damping valve mechanism 227 opens during the compression stroke of the shock absorber 1 to allow the oil fluid L to flow from the lower chamber 20 to the reservoir chamber 6 and generate a damping force. The disc valve 223, together with the base valve member 221, constitutes a suction valve mechanism 228. The suction valve mechanism 228 opens during the extension stroke of the shock absorber 1 to allow the oil fluid L to flow from the reservoir chamber 6 to the lower chamber 20. Further, the suction valve mechanism 228 performs a function of causing the oil fluid L to flow from the reservoir chamber 6 to the lower chamber 20 substantially without generating a damping force so that a shortage of the oil fluid L caused mainly due to extension of the rod 21 from the cylinder 2 is supplemented.

Next, main operations of the shock absorber 1 will be described.

“In case of assuming that frequency sensitive mechanism 130 does not act, and only first damping force generation mechanism 41 and second damping force generation mechanism 110 on extension side act during extension stroke”

In this case, when a moving speed of the piston 18 (hereinafter referred to as a piston speed) is lower than a first predetermined value, the oil fluid L from the upper chamber 19 flows into the lower chamber 20 through the first passage 43 and the fixed orifice 92 of the first damping force generation mechanism 41 illustrated in FIG. 2. Therefore, a damping force having orifice characteristics (in which the damping force is substantially proportional to the square of the piston speed) is generated. Therefore, the damping force characteristics with respect to the piston speed when the piston speed is lower than the first predetermined value are such that an increasing rate of the damping force with respect to an increase in the piston speed is relatively high.

When the piston speed is equal to or higher than the first predetermined value and lower than a second predetermined value, the oil fluid L from the upper chamber 19 passes through the first passage 43, the passage in the notch 81, the passage in the groove part 30, the passage in the passage groove 79, and the back pressure chamber 100, and then flows into the lower chamber 20 through between the disc valve 99 and the valve seat part 75 while opening the disc valve 99 of the second damping force generation mechanism 110. Therefore, a damping force having valve characteristics (in which the damping force is substantially proportional to the piston speed) is generated. Therefore, the damping force characteristics with respect to the piston speed when the piston speed is equal to or higher than the first predetermined value and lower than the second predetermined value are such that an increasing rate of the damping force with respect to an increase in the piston speed is lower than that when the piston speed is lower than the first predetermined value.

When the piston speed increases to the second predetermined value or higher, a relationship of a force (hydraulic pressure) acting on the damping valve 91 of the first damping force generation mechanism 41 is such that a force in an opening direction exerted from the first passage 43 is larger than a force in a closing direction exerted from the back pressure chamber 100. Therefore, in this region, as the piston speed increases, the damping valve 91 is separated from the valve seat part 48 of the piston 18 and opens. Therefore, the oil fluid L from the upper chamber 19 flows from the first passage 43 to the lower chamber 20 through between the damping valve 91 and the valve seat part 48 while opening the damping valve 91 in addition to a flow to the lower chamber 20 through between the disc valve 99 and the valve seat part 75 while opening the disc valve 99 described above. Therefore, an increasing rate of the damping force with respect to an increase in the piston speed when the piston speed is equal to or higher than the second predetermined value is lower than that when the piston speed is equal to or higher than the first predetermined value and lower than the second predetermined value.

“In case of assuming that frequency sensitive mechanism 130 does not act, and only first damping force generation mechanism 42 on compression side acts during compression stroke”

In this case, when the piston speed is lower than a third predetermined value, the oil fluid L from the lower chamber 20 flows into the upper chamber 19 via the first passage 44 and the fixed orifice 123 of the first damping force generation mechanism 42. Thereby, a damping force having orifice characteristics is generated. Therefore, the damping force characteristics with respect to the piston speed when the piston speed is lower than the third predetermined value are such that an increasing rate of the damping force with respect to an increase in the piston speed is relatively high.

When the piston speed increases to the third predetermined value or higher, the oil fluid L introduced from the lower chamber 20 into the first passage 44 flows into the upper chamber 19 through between the disc valve 122 and the valve seat part 49 while opening the disc valve 122 of the first damping force generation mechanism 42. Thereby, a damping force having valve characteristics is generated. Therefore, the damping force characteristics with respect to the piston speed when the piston speed is equal to or higher than the third predetermined value are such that an increasing rate of the damping force with respect to an increase in the piston speed is lower than that when the piston speed is lower than the third predetermined value.

“In case in which frequency sensitive mechanism 130 acts during extension stroke”

In the first embodiment, the frequency sensitive mechanism 130 makes a damping force variable according to the piston frequency even when the piston speed is the same.

In the extension stroke, the oil fluid L is introduced from the upper chamber 19 into the first chamber 181 of the frequency sensitive mechanism 130 via the first passage 43, the passage in the notch 81, the passage in the groove part 30, and the passage in the passage groove 158. Then, in the valve member 133 that has been in contact with the flexible member 135, the seat part 154, and the support member 143, the valve disc 171 causes the flexible member 135, that is in contact therewith at the first support part 178, to bend in a direction away from the bottom part 150 in the axial direction of the case member 131. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135 as a fulcrum.

When the introduction of the oil fluid L into the first chamber 181 further progresses, the flexible member 135 comes into contact with the stopper 142, and the bending is restricted, the valve disc 171 is bent in a tapered shape so that the second support part 179 is further separated from the bottom part 150 in the axial direction of the case member 131 with respect to the first support part 178 using a contact point with the flexible member 135 as a fulcrum while further compressively deforming the biasing part 174 in the axial direction of the case member 131 between the valve disc 171 and the support member 143.

The valve member 133 increases a volume of the first chamber 181 as described above to introduce the oil fluid L into the first chamber 181. At that time, the valve member 133 discharges the oil fluid L from the second chamber 182 to the lower chamber 20 through the passage part 185.

Here, in an extension stroke when the piston frequency is high, a stroke of the piston 18 is small. Therefore, an amount of the oil fluid L introduced from the upper chamber 19 into the first chamber 181 via the first passage 43, the passage in the notch 81, the passage in the groove part 30, and the passage in the passage groove 158 is small. Therefore, the valve member 133 deforms as described above, but does not deform to near the limit.

Therefore, in the extension stroke when the piston frequency is high, the valve member 133 of the frequency sensitive mechanism 130 moves and bends as described above while bending the flexible member 135 each time the extension stroke occurs, and thereby the oil fluid L is introduced from the upper chamber 19 into the first chamber 181. Then, a flow rate of the oil fluid L flowing from the upper chamber 19 to the lower chamber 20 through the first passage 43, the passage in the notch 81, the passage in the groove part 30, the passage in the passage groove 79, and the back pressure chamber 100 while opening the disc valve 99 of the second damping force generation mechanism 110 is reduced. Also, in addition to this, a flow rate of the oil fluid L flowing from the first passage 43 into the lower chamber 20 while opening the damping valve 91 of the first damping force generation mechanism 41 is also reduced. In addition, when the oil fluid L is introduced from the upper chamber 19 into the first chamber 181, an increase in pressure of the back pressure chamber 100 is suppressed compared to a case without the first chamber 181, and the damping valve 91 of the first damping force generation mechanism 41 becomes easier to open. Thereby, the extension-side damping force becomes soft.

On the other hand, in an extension stroke when the piston frequency is low, the stroke of the piston 18 is large. Therefore, an amount of the oil fluid L introduced from the upper chamber 19 into the first chamber 181 via the first passage 43, the passage in the notch 81, the passage in the groove part 30, and the passage in the passage groove 158 is large. Therefore, although the oil fluid L flows from the upper chamber 19 to the first chamber 181 at the beginning of the stroke of the piston 18, thereafter the flexible member 135 and the valve member 133 deform to near the limit and does not deform more than that. As a result, the oil fluid L does not flow from the upper chamber 19 to the first chamber 181. Thereby, a flow rate of the oil fluid L flowing from the upper chamber 19 to the lower chamber 20 through the first passage 43, the passage in the notch 81, the passage in the groove part 30, the passage in the passage groove 79, and the back pressure chamber 100 while opening the second damping force generation mechanism 110 is not reduced. Also, in addition to this, a flow rate of the oil fluid L flowing from the first passage 43 into the lower chamber 20 while opening the damping valve 91 of the first damping force generation mechanism 41 is neither reduced. In addition, when the oil fluid L is not introduced into the first chamber 181 from the upper chamber 19, the pressure in the back pressure chamber 100 increases, making it difficult for the damping valve 91 of the first damping force generation mechanism 41 to open. Thereby, in the extension stroke when the piston frequency is low, the damping force becomes harder than when the piston frequency is high.

In the compression stroke, the pressure in the lower chamber 20 increases, but the valve disc 171 of the valve member 133 of the frequency sensitive mechanism 130 comes into contact with the seat part 154 of the case member 131 at the second support part 179 to suppress expansion of the second chamber 182. Therefore, an amount of the oil fluid L introduced into the second chamber 182 from the lower chamber 20 through the passage part 185 is suppressed. As a result, it becomes a state in which a flow rate of the oil fluid L introduced from the lower chamber 20 into the first passage 44, passing through the first damping force generation mechanism 42, and flowing into the upper chamber 19 is not reduced. Therefore, the damping force becomes hard. In the compression stroke, when the piston speed increases and a pressure in the second chamber 182 becomes higher than a pressure in the first chamber 181 by a predetermined value or more, the first support part 178 on the inner circumferential side of the valve member 133 separates from the flexible member 135. In other words, the check valve 193 opens. Thereby, the oil fluid L flows from the lower chamber 20 to the upper chamber 19 via the passage part 185, the second chamber 182, the check valve 193, the first chamber 181, the passage in the passage groove 158, the passage in the groove part 30, the passage in the notch 81, and the first passage 43. As described above, the valve member 133 reduces a differential pressure between the second chamber 182 side and the first chamber 181 side when the check valve 193 opens. Therefore, excessive bending of the valve member 133 is suppressed.

The above-described Patent Document 1 describes a shock absorber that uses a bendable disc as a valve. When a bendable plate-shaped valve is used, it is required to enhance durability thereof.

In the shock absorber 1 of the first embodiment, the bendable plate-shaped valve member 133 is provided in the second passage 191 that allows communication between the upper chamber 19 on one side and the lower chamber 20 on the other side inside the cylinder 2. The valve member 133 includes the first support part 178 supported at one surface on a radially inner side, the second support part 179 disposed on an outer side of the first support part 178 in the radial direction of the valve member 133 and supported at one surface, and a biasing part 174 at least a part of which is provided on an outer side of the second support part 179 in the radial direction of the valve member 133 to bias the second support part 179 side of the valve member 133. Then, the shock absorber 1 includes the flexible member 135 that is in contact with the first support part 178 of the valve member 133 and is bendable together with the valve member 133. As described above, in the shock absorber 1, the flexible member 135 that is in contact with the first support part 178 of the valve member 133 is bendable. Therefore, in the shock absorber 1, an amount of bending of the valve member 133 is suppressed by an amount corresponding to the bending of the flexible member 135 compared to a case in which the first support part 178 is supported by a member that does not bend. Therefore, the shock absorber 1 can suppress excessive bending of the valve member 133 while securing a volume of the oil fluid L that can be received in the first chamber 181. Therefore, the shock absorber 1 can enhance durability of the valve member 133.

Here, when the valve member 133 functions as a partitioning member of the frequency sensitive mechanism 130, initial ease of movement of the valve member 133 when the first chamber 181 receives the oil fluid L influences a damping force when high-frequency vibrations are input to the shock absorber 1. In a conventional structure, a portion supporting the first support part 178 of the valve member 133 has been fixed to the rod 21, but in the shock absorber 1 of the present embodiment, the flexible member 135 that can be bent together with the valve member 133 is used for the support portion. Therefore, in the shock absorber 1, the flexible member 135 is movable in the axial direction with respect to the rod 21, and compared to the conventional structure, initial movement of the valve member 133 when the first chamber 181 receives the oil fluid L can be made easier.

Also, in the shock absorber 1, since the stopper 142 suppresses an amount of bending of the flexible member 135, durability of the flexible member 135 can be enhanced.

Also, in the shock absorber 1, since the valve member 133 can be bent even if bending of the flexible member 135 is suppressed by the stopper 142, bending of the valve member 133 is not excessively suppressed by the stopper 142 and the flexible member 135. Therefore, a volume of the oil fluid L that can be received in the first chamber 181 can be secured.

Also, in the shock absorber 1, since the flexible member 135 is formed of an annular plate-shaped member, an increase in costs due to provision of the flexible member 135 can be suppressed.

### Second Embodiment

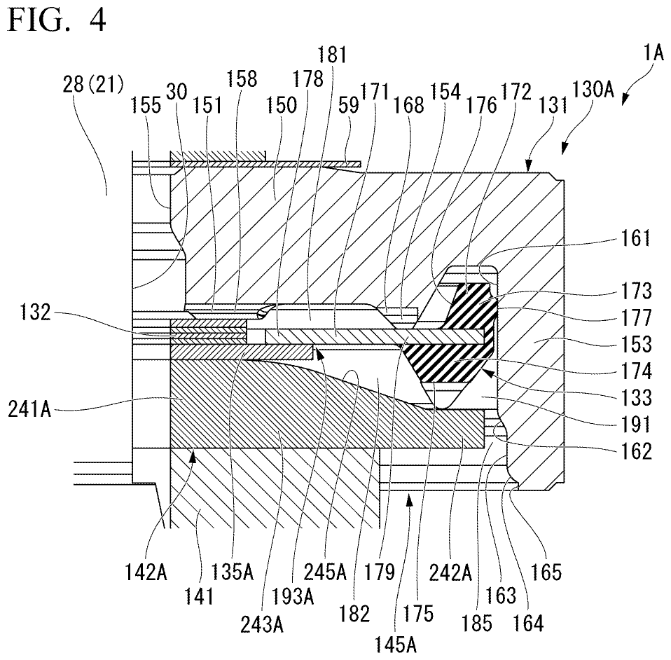

Next, a second embodiment will be described mainly on the basis of FIG. 4, focusing on the differences from the first embodiment. Further, portions common to those in the first embodiment will be denoted by the same terms and the same reference signs.

As illustrated in FIG. 4, a shock absorber 1A of the second embodiment includes a frequency sensitive mechanism 130A, which is partially different from the frequency sensitive mechanism 130, instead of the frequency sensitive mechanism 130.

The frequency sensitive mechanism 130A includes a valve case 145A, which is partially different from the valve case 145, instead of the valve case 145. The number of discs 132 in the valve case 145A is different from the number of discs 132 in the valve case 145. A total thickness of all the discs 132 of the valve case 145A is equal to a total thickness of all the discs 132 of the valve case 145.

Also, the valve case 145A includes a flexible member 135A, which is different from the flexible member 135 in that a thickness thereof is larger than that of the flexible member 135, instead of the flexible member 135. The thickness of the flexible member 135A is equal to a thickness of the valve disc 171. In the valve case 145A, a position of an end surface of the flexible member 135A on a bottom part 150 side in an axial direction of a case member 131 is the same as a position of the end surface of the flexible member 135 of the valve case 145 on the bottom part 150 side in the axial direction of the case member 131.

Also, the valve case 145A includes a stopper 142A formed of one member instead of the disc 136, the stopper disc 137, the stopper discs 138, the stopper discs 139, and support member 143 of the first embodiment.

The stopper 142A has a bored disc shape and has a constant radial width over the entire circumference. The stopper 142A has a thick part 241A, a thin part 242A, and a connection part 243A. The thick part 241A is at an end portion of the stopper 142A on an inner circumferential side in a radial direction. The thin part 242A is at an end portion of the stopper 142A on an outer circumferential side in the radial direction. The connection part 243A is positioned between the thick part 241A and the thin part 242A in the radial direction of the stopper 142A. The thick part 241A, the thin part 242A, and the connection part 243A have their positions of end surfaces on one side that are aligned in the axial direction of the case member 131.

The thick part 241A has a constant radial width over the entire circumference. A mounting shaft part 28 of a rod 21 is fitted in the thick part 241A. Thereby, the stopper 142A is made to coincide with the rod 21 in central axis. The thick part 241A is in contact with the flexible member 135A and an annular member 141. A radial width of the thick part 241A is smaller than a radial width of the flexible member 135A.

In an axial direction of the stopper 142A, the thin part 242A has a smaller thickness than the thick part 241A. In the axial direction of the stopper 142A, the thin part 242A is provided at an end portion opposite to the flexible member 135A. The thin part 242A has a constant outer diameter over the entire circumference and a constant radial width over the entire circumference. The outer diameter of the thin part 242A is the same as the outer diameter of the support member 143 of the first embodiment. The thickness of the thin part 242A is the same as the thickness of the support member 143 of the first embodiment. In the valve case 145A, a position of an end surface of the thin part 242A on the bottom part 150 side in the axial direction of the case member 131 is the same as a position of the end surface of the support member 143 of the valve case 145 on the bottom part 150 side in the axial direction of the case member 131.

The connection part 243A has an inclined part 245A on the flexible member 135A side in the axial direction of the stopper 142A. An outer diameter of the inclined part 245A increases with distance away from the flexible member 135A in the axial direction of the stopper 142A. In other words, the outer diameter of the inclined part 245A increases toward the thin part 242A in the axial direction of the stopper 142A. In yet other words, an outer diameter of a portion of the inclined part 245A on a side opposite to the flexible member 135A in the axial direction of the stopper 142A is formed to be larger than an outer diameter of a portion of the inclined part 245A on the flexible member 135A side. An end portion of the inclined part 245A on the flexible member 135A side in the axial direction has a curved surface shape, and an end portion thereof at an intermediate portion and on a side opposite to the flexible member 135A in the axial direction has a tapered shape.

A valve member 133 is supported by the flexible member 135A with one surface of a first support part 178 on a side opposite to the bottom part 150 in the axial direction in contact with the flexible member 135A. The valve member 133 is supported by a seat part 154 with one surface of a second support part 179 on the bottom part 150 side in the axial direction in contact with the seat part 154. The valve member 133 is supported by the thin part 242A with a biasing part 174 thereof in contact with the thin part 242A of the stopper 142A at a portion disposed on a radially outer side of the second support part 179. The thin part 242A suppresses movement of the valve member 133 in a direction opposite to the bottom part 150 and the seat part 154 in the axial direction.

An outer diameter of the flexible member 135A is larger than a diameter of the thick part 241A that is in contact with a surface on a side opposite to the first support part 178 in the axial direction. Therefore, the flexible member 135A is bendable in a direction away from the bottom part 150 in the axial direction. The valve member 133 is bendable such that the second support part 179 is separated from the seat part 154 while the first support part 178 remains in contact with the flexible member 135A. When bending in this manner, the valve member 133 is bent to move the second support part 179 to a side opposite to the bottom part 150 in the axial direction of the case member 131 with respect to the first support part 178.

The flexible member 135A is bendable together with the valve member 133. The flexible member 135A is bent in a direction opposite to the bottom part 150 due to movement and deformation of the valve member 133 to a side opposite to the seat part 154 in the axial direction. The stopper 142A suppresses an amount of bending of the flexible member 135A by coming into contact with the flexible member 135A that bends in that manner. Here, even if bending of the flexible member 135A is suppressed by the stopper 142A, the valve member 133 is bendable to move the second support part 179 further to a side opposite to the bottom part 150 in the axial direction of the case member 131 with respect to the first support part 178.

In the shock absorber 1A of the second embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 4, and a passage in a passage groove 158 of the case member 131. Then, the valve disc 171 of the valve member 133 bends the flexible member 135A, that is in contact therewith at the first support part 178, in a direction away from the bottom part 150 in the axial direction of the case member 131. At the same time, the valve disc 171 compressively deforms the biasing part 174 that is in contact with the thin part 242A of the stopper 142A in the axial direction of the case member 131 between itself and the thin part 242A. At the same time, the valve disc 171 is bent in a tapered shape so that the second support part 179 is separated from the bottom part 150 in the axial direction of the case member 131 with respect to the first support part 178 using a contact point with the flexible member 135A as a fulcrum. In this way, the valve disc 171 is bent so that the second support part 179 is separated from the bottom part 150 in the axial direction of the case member 131 with respect to the first support part 178 using a contact point with the flexible member 135A as a fulcrum while moving away from the bottom part 150 in the axial direction of the case member 131.

As the introduction of the oil fluid L into the first chamber 181 further progresses, the flexible member 135A comes into contact with the inclined part 245A of the stopper 142A, and thereby bending is restricted. Then, the valve disc 171 is bent in a tapered shape so that the second support part 179 is further separated from the bottom part 150 in the axial direction of the case member 131 with respect to the first support part 178 using a contact point with the flexible member 135A as a fulcrum while further compressively deforming the biasing part 174 in the axial direction of the case member 131 between the valve disc 171 and the thin part 242A.

Due to the movement and deformation of the valve disc 171 as described above, the valve member 133 increases a volume of the first chamber 181.

Here, a space between the first support part 178 of the valve disc 171 and the flexible member 135A is closed when they are in contact with each other and opens when they are separated from each other, thereby forming a check valve 193A that operates in the same manner as the check valve 193.

The shock absorber 1A of the second embodiment includes the flexible member 135A that is in contact with the first support part 178 of the valve member 133 and is bendable together with the valve member 133. Therefore, similarly to the shock absorber 1, the shock absorber 1A can enhance durability of the valve member 133 while securing a volume of the oil fluid L that can be received in the first chamber 181. At the same time, the shock absorber 1A can facilitate initial movement of the valve member 133 when the first chamber 181 receives the oil fluid L.

Also, in the shock absorber 1A, since the stopper 142A suppresses an amount of bending of the flexible member 135A, durability of the flexible member 135A can be enhanced as in the shock absorber 1.

Also, in the shock absorber 1A, since the valve member 133 can be bent even if bending of the flexible member 135A is suppressed by the stopper 142A, a volume of the oil fluid L that can be received in the first chamber 181 can be further secured as in the shock absorber 1.

Also, in the shock absorber 1A, since the flexible member 135A is formed of an annular plate-shaped member, an increase in costs due to provision of the flexible member 135A can be suppressed as in the shock absorber 1.

Also, in the shock absorber 1A, since bending of the flexible member 135A is suppressed and the biasing part 174 of the valve member 133 is supported by the stopper 142A formed of one member, the number of parts can be reduced and management costs can be reduced.

### Third Embodiment

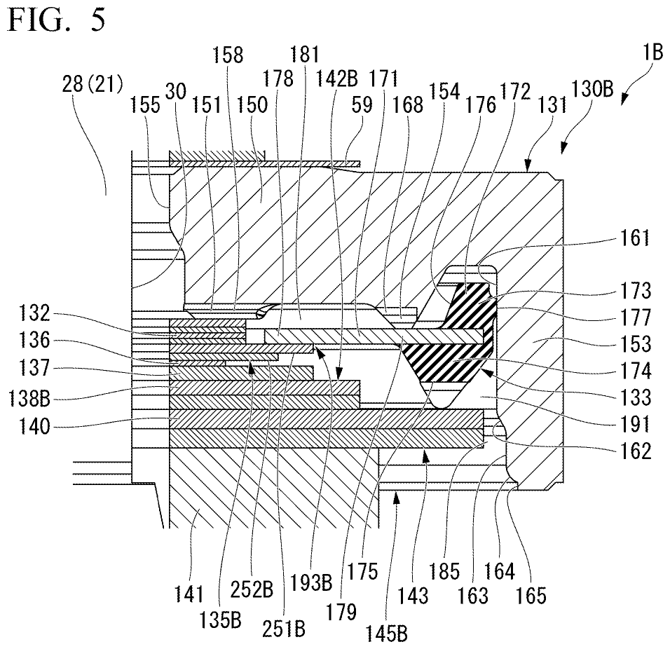

Next, a third embodiment will be described mainly on the basis of FIG. 5, focusing on the differences from the first embodiment. Further, portions common to those in the first embodiment will be denoted by the same terms and the same reference signs.

As illustrated in FIG. 5, a shock absorber 1B of the third embodiment includes a frequency sensitive mechanism 130B, which is partially different from the frequency sensitive mechanism 130, instead of the frequency sensitive mechanism 130.

The frequency sensitive mechanism 130B includes a valve case 145B, which is partially different from the valve case 145, instead of the valve case 145. The number of discs 132 in the valve case 145B is different from the number of discs 132 in the valve case 145. A total thickness of all the discs 132 of the valve case 145B is equal to a total thickness of all the discs 132 of the valve case 145.

The valve case 145B includes a flexible member 135B (plate-shaped member) instead of the flexible member 135. The flexible member 135B is formed of a plurality of (specifically, two) annular members 251B and 252B. The annular member 251B is a part similar to the flexible member 135. The annular member 252B is made of a metal. The annular member 252B has a bored disc shape. The annular member 252B has a constant outer diameter over the entire circumference and a constant radial width over the entire circumference.

The annular member 251B is on a bottom part 150 side, that is, on a valve disc 171 side, with respect to the annular member 252B in an axial direction of a case member 131. An outer diameter of the annular member 252B is smaller than an outer diameter of the annular member 251B. In other words, the plurality of annular members 251B and 252B are formed such that the outer diameter of the annular member 252B provided on a side opposite to a valve member 133 is smaller than the outer diameter of the annular member 251B provided on the valve member 133 side. A thickness of the annular member 251B is larger than a thickness of the annular member 252B. The outer diameter of the annular member 252B is larger than an outer diameter of a disc 136.

A mounting shaft part 28 of a rod 21 is fitted inside both the annular members 251B and 252B. Thereby, both the annular members 251B and 252B are made to coincide with the rod 21 in central axis. Both the annular members 251B and 252B are elastically deformable, that is, bendable. The annular members 251B and 252B are in contact with each other in the axial direction. The flexible member 135B having the annular members 251B and 252B is elastically deformable, that is, bendable.

The valve case 145B includes a stopper 142B, which is partially different from the stopper 142, instead of the stopper 142. The stopper 142B includes a plurality of (specifically, two) stopper discs 138B having the same outer diameter and the same inner diameter instead of the stopper discs 138 and 139. The stopper discs 138B are different from the stopper discs 138 and 139 in outer diameter. The stopper discs 138B have an outer diameter larger than an outer diameter of a stopper disc 137 and smaller than an outer diameter of a disc 140. In the valve case 145B, a position of an end surface of a support member 143 on the bottom part 150 side in the axial direction of the case member 131 is the same as a position of the end surface of the support member 143 of the valve case 145 on the bottom part 150 side in the axial direction of the case member 131.

The valve member 133 is supported by the flexible member 135B with one surface of a first support part 178 on a side opposite to the bottom part 150 in the axial direction in contact with the annular member 251B of the flexible member 135B. At that time, the first support part 178 overlaps both the annular members 251B and 252B in radial position.

Similarly to the valve member 133 of the frequency sensitive mechanism 130, the valve member 133 of the frequency sensitive mechanism 130B is configured such that a second support part 179 is supported by a seat part 154, and a biasing part 174 is supported by the support member 143.

In the flexible member 135B, the outer diameters of the annular members 251B and 252B are both larger than the outer diameter of the disc 136. The valve member 133 is bendable such that the second support part 179 is separated from the seat part 154 while the first support part 178 remains in contact with the flexible member 135B. When bending in this manner, the valve member 133 is bent to move the second support part 179 to a side opposite to the bottom part 150 in the axial direction of the case member 131 with respect to the first support part 178.

The flexible member 135B is bendable together with the valve member 133. The flexible member 135B is bent in a direction opposite to the bottom part 150 due to movement and deformation of the valve member 133 to a side opposite to the seat part 154 in the axial direction. The stopper 142B having the stopper discs 137 and 138B suppresses an amount of bending of the flexible member 135B with the stopper disc 137 coming into contact with the flexible member 135B that bends in that manner. Here, even if bending of the flexible member 135B is suppressed by the stopper 142B, the valve member 133 is bendable to move the second support part 179 further to a side opposite to the bottom part 150 in the axial direction of the case member 131 with respect to the first support part 178.

In the shock absorber 1B of the third embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 5, and a passage in a passage groove 158 of the case member 131. Then, the valve disc 171 of the valve member 133 bends the flexible member 135B, that is in contact therewith at the first support part 178, in a direction away from the bottom part 150 in the axial direction of the case member 131. At that time, the valve disc 171 bends both the annular members 251B and 252B. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135B as a fulcrum. In this way, the valve disc 171 is bent so that the second support part 179 is separated from the bottom part 150 in the axial direction of the case member 131 with respect to the first support part 178 using a contact point with the flexible member 135B as a fulcrum while moving away from the bottom part 150 in the axial direction of the case member 131.

As the introduction of the oil fluid L into the first chamber 181 further progresses, the annular member 252B of the flexible member 135B comes into contact with the stopper disc 137, and thereby bending is restricted. Then, the valve disc 171 bends the annular member 251B in a direction away from the bottom part 150 in the axial direction of the case member 131. At the same time, the valve disc 171 is bent in a tapered shape so that the second support part 179 is further separated from the bottom part 150 in the axial direction of the case member 131 with respect to the first support part 178 using a contact point with the flexible member 135B as a fulcrum while further compressively deforming the biasing part 174 in the axial direction of the case member 131 between the valve disc 171 and the support member 143.

As the introduction of the oil fluid L into the first chamber 181 further progresses, the annular member 251B comes into contact with the stopper disc 137, and thereby bending is restricted. Then, the valve disc 171 is bent in a tapered shape so that the second support part 179 is further separated from the bottom part 150 in the axial direction of the case member 131 with respect to the first support part 178 using a contact point with the flexible member 135B as a fulcrum while further compressively deforming the biasing part 174 in the axial direction of the case member 131 between the valve disc 171 and the support member 143.

Due to the movement and deformation of the valve disc 171 as described above, the valve member 133 increases a volume of the first chamber 181.

Here, a space between the first support part 178 of the valve disc 171 and the annular member 251B of the flexible member 135B is closed when they are in contact with each other and opens when they are separated from each other, thereby forming a check valve 193B that operates in the same manner as the check valve 193.

The shock absorber 1B of the third embodiment includes the flexible member 135B that is in contact with the first support part 178 of the valve member 133 and is bendable together with the valve member 133. Therefore, similarly to the shock absorber 1, the shock absorber 1B can enhance durability of the valve member 133 while securing a volume of the oil fluid L that can be received in the first chamber 181. At the same time, the shock absorber 1B can facilitate initial movement of the valve member 133 when the first chamber 181 receives the oil fluid L.

Also, in the shock absorber 1B, since the stopper 142B suppresses an amount of bending of the flexible member 135B, durability of the flexible member 135B can be enhanced as in the shock absorber 1.

Also, in the shock absorber 1B, since the valve member 133 can be bent even if bending of the flexible member 135B is suppressed by the stopper 142B, a volume of the oil fluid L that can be received in the first chamber 181 can be further secured as in the shock absorber 1.

Also, in the shock absorber 1B, since the flexible member 135B is formed of an annular plate-shaped member, an increase in costs due to provision of the flexible member 135B can be suppressed as in the shock absorber 1.

Also, in the shock absorber 1B, the flexible member 135B includes the plurality of annular members 251B and 252B. These annular members 251B and 252B are formed such that the outer diameter of the annular member 252B provided on a side opposite to the valve member 133 is smaller than the outer diameter of the annular member 251B provided on the valve member 133 side. Therefore, a spring constant, that is, bending characteristics, of the flexible member 135B can be changed.

### Fourth Embodiment

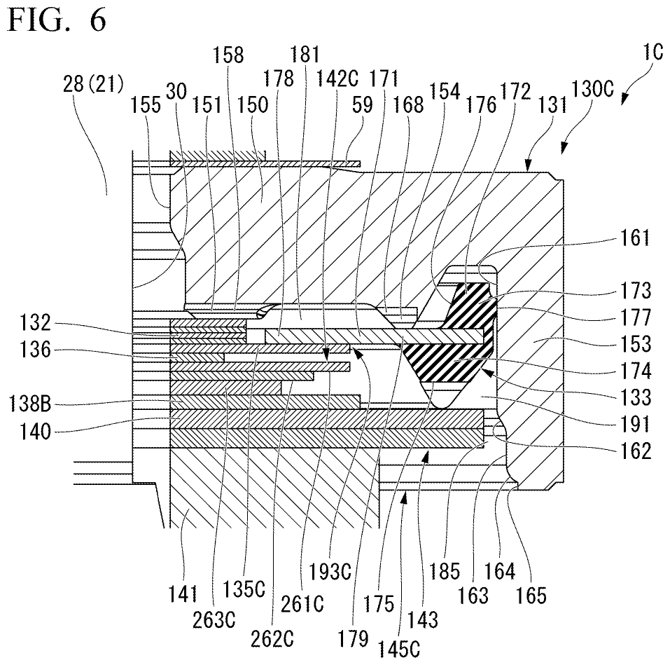

Next, a fourth embodiment will be described mainly on the basis of FIG. 6, focusing on the differences from the third embodiment. Further, portions common to those in the third embodiment will be denoted by the same terms and the same reference signs.

As illustrated in FIG. 6, a shock absorber 1C of the fourth embodiment includes a frequency sensitive mechanism 130C, which is partially different from the frequency sensitive mechanism 130B, instead of the frequency sensitive mechanism 130.

The frequency sensitive mechanism 130C includes a valve case 145C, which is partially different from the valve case 145B, instead of the valve case 145B.

The valve case 145C includes a flexible member 135C (plate-shaped member) instead of the flexible member 135B. The flexible member 135C is different from the annular member 251B of the flexible member 135B in that an outer diameter thereof is larger than the outer diameter of the annular member 251B. The flexible member 135C does not include the annular member 252B.

The valve case 145C includes a stopper 142C, which is partially different from the stopper 142B, instead of the stopper 142B. The stopper 142C includes a plurality of (specifically, three) plate-shaped stopper members 261C, 262C, and 263C instead of the stopper disc 137 and one of the stopper discs 138B. The plate-shaped stopper members 261C, 262C, and 263C are all made of a metal. The plate-shaped stopper members 261C, 262C, and 263C are all formed of an annular plate-shaped member.

The plate-shaped stopper members 261C, 262C, and 263C each have a bored circular flat plate shape with a constant thickness. The plate-shaped stopper members 261C, 262C, and 263C each have a constant outer diameter over the entire circumference and a constant radial width over the entire circumference. All the plate-shaped stopper members 261C, 262C, and 263C have a mounting shaft part 28 fitted to the inside of them. Thereby, all the plate-shaped stopper members 261C, 262C, and 263C are made to coincide with a rod 21 in central axis.

The plate-shaped stopper member 261C is on a bottom part 150 side, that is, on a valve disc 171 side, with respect to the plate-shaped stopper member 262C in an axial direction of a case member 131. The outer diameter of the plate-shaped stopper member 261C is equal to the outer diameter of the flexible member 135C.

The outer diameter of the plate-shaped stopper member 262C is smaller than the outer diameter of the plate-shaped stopper member 261C. The plate-shaped stopper member 262C is on a side opposite to the valve disc 171 with respect to the plate-shaped stopper member 261C in an axial direction of the case member 131.

The outer diameter of the plate-shaped stopper member 263C is smaller than the outer diameter of the plate-shaped stopper member 262C. The plate-shaped stopper member 263C is on a side opposite to the valve disc 171 with respect to the plate-shaped stopper member 262C in the axial direction of the case member 131. One stopper disc 138B is provided between the plate-shaped stopper member 263C and a disc 140 in the axial direction of the case member 131.

As described above, the plurality of plate-shaped stopper members 261C and 262C are formed such that the outer diameter of the plate-shaped stopper member 262C provided on a side opposite to a valve member 133 is smaller than the outer diameter of the plate-shaped stopper member 261C provided on the valve member 133 side. Also, the plurality of plate-shaped stopper members 262C and 263C are formed such that the outer diameter of the plate-shaped stopper member 263C provided on a side opposite to the valve member 133 is smaller than the outer diameter of the plate-shaped stopper member 262C provided on the valve member 133 side.

The plurality of plate-shaped stopper members 261C and 262C have the same thickness, which is smaller than a thickness of the plate-shaped stopper member 263C. In the stopper 142C having the plate-shaped stopper members 261C, 262C, and 263C, the plate-shaped stopper members 261C and 262C are elastically deformable, that is, bendable.

In the valve case 145C, a position of an end surface of a support member 143 on the bottom part 150 side in the axial direction of the case member 131 is the same as a position of the end surface of the support member 143 of the valve case 145B on the bottom part 150 side in the axial direction of the case member 131.

The valve member 133 is supported by the flexible member 135C with one surface of a first support part 178 on a side opposite to the bottom part 150 in the axial direction in contact with the flexible member 135C.

Similarly to the valve member 133 of the frequency sensitive mechanism 130B, the valve member 133 of the frequency sensitive mechanism 130C is configured such that a second support part 179 is supported by a seat part 154, and a biasing part 174 is supported by the support member 143.

The outer diameter of the flexible member 135C is larger than the outer diameter of the annular member 251B. The valve member 133 is bendable such that the second support part 179 is separated from the seat part 154 while the first support part 178 remains in contact with the flexible member 135C. When bending in this manner, the valve member 133 is bent to move the second support part 179 to a side opposite to the bottom part 150 in the axial direction of the case member 131 with respect to the first support part 178.

The flexible member 135C is bendable together with the valve member 133. The flexible member 135C is bent in a direction opposite to the bottom part 150 due to movement and deformation of the valve member 133 to a side opposite to the seat part 154 in the axial direction. The stopper 142C suppresses an amount of bending of the flexible member 135C by coming into contact with the flexible member 135C that bends in that manner. Here, even if bending of the flexible member 135C is suppressed by the stopper 142C, the valve member 133 is bendable to move the second support part 179 further to a side opposite to the bottom part 150 in the axial direction of the case member 131 with respect to the first support part 178.

In the shock absorber 1C of the fourth embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 6, and a passage in a passage groove 158 of the case member 131. Then, the valve disc 171 of the valve member 133 bends the flexible member 135C, that is in contact therewith at the first support part 178, in a direction away from the bottom part 150 in the axial direction of the case member 131. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135C as a fulcrum. In this way, the valve disc 171 is bent so that the second support part 179 is separated from the bottom part 150 in the axial direction of the case member 131 with respect to the first support part 178 using a contact point with the flexible member 135C as a fulcrum while moving away from the bottom part 150 in the axial direction of the case member 131.

As the introduction of the oil fluid L into the first chamber 181 further progresses, the flexible member 135C comes into contact with the plate-shaped stopper member 261C of the stopper 142C, and thereby bending is suppressed by the plate-shaped stopper member 261C. Then, the valve disc 171 is bent in a tapered shape so that the second support part 179 is further separated from the bottom part 150 in the axial direction of the case member 131 with respect to the first support part 178 using a contact point with the flexible member 135C as a fulcrum while further compressively deforming the biasing part 174 in the axial direction of the case member 131 between the valve disc 171 and the support member 143. At that time, the plate-shaped stopper member 261C also bends together with the flexible member 135C.

When the valve disc 171 is bent in a tapered shape so that the second support part 179 is further separated from the bottom part 150 in the axial direction of the case member 131 with respect to the first support part 178 using a contact point with the flexible member 135C as a fulcrum, the plate-shaped stopper members 261C and 262C bend together with flexible member 135C.

Due to the movement and deformation of the valve disc 171 as described above, the valve member 133 increases a volume of the first chamber 181.

Here, a space between the first support part 178 of the valve disc 171 and the flexible member 135C is closed when they are in contact with each other and opens when they are separated from each other, thereby forming a check valve 193C that operates in the same manner as the check valve 193.

The shock absorber 1C of the fourth embodiment includes the flexible member 135C that is in contact with the first support part 178 of the valve member 133 and is bendable together with the valve member 133. Therefore, similarly to the shock absorber 1, the shock absorber 1C can enhance durability of the valve member 133 while securing a volume of the oil fluid L that can be received in the first chamber 181. At the same time, the shock absorber 1C can facilitate initial movement of the valve member 133 when the first chamber 181 receives the oil fluid L.

Also, in the shock absorber 1C, since the stopper 142C suppresses an amount of bending of the flexible member 135C, durability of the flexible member 135C can be enhanced as in the shock absorber 1.

Also, in the shock absorber 1C, since the valve member 133 can be bent even if bending of the flexible member 135C is suppressed by the stopper 142C, a volume of the oil fluid L that can be received in the first chamber 181 can be further secured as in the shock absorber 1.

Also, in the shock absorber 1C, since the flexible member 135C is formed of an annular plate-shaped member, an increase in costs due to provision of the flexible member 135C can be suppressed as in the shock absorber 1.

Also, in the shock absorber 1C, the stopper 142C includes the plurality of plate-shaped stopper members 261C, 262C, and 263C each formed of an annular plate-shaped member. The plurality of plate-shaped stopper members 261C and 262C are formed such that the outer diameter of the plate-shaped stopper member 262C provided on a side opposite to a valve member 133 is smaller than the outer diameter of the plate-shaped stopper member 261C provided on the valve member 133 side. Also, the plurality of plate-shaped stopper members 262C and 263C are formed such that the outer diameter of the plate-shaped stopper member 263C provided on a side opposite to the valve member 133 is smaller than the outer diameter of the plate-shaped stopper member 262C provided on the valve member 133 side. Therefore, a spring constant, that is, bending characteristics, of the stopper 142C can be changed.

### Fifth Embodiment

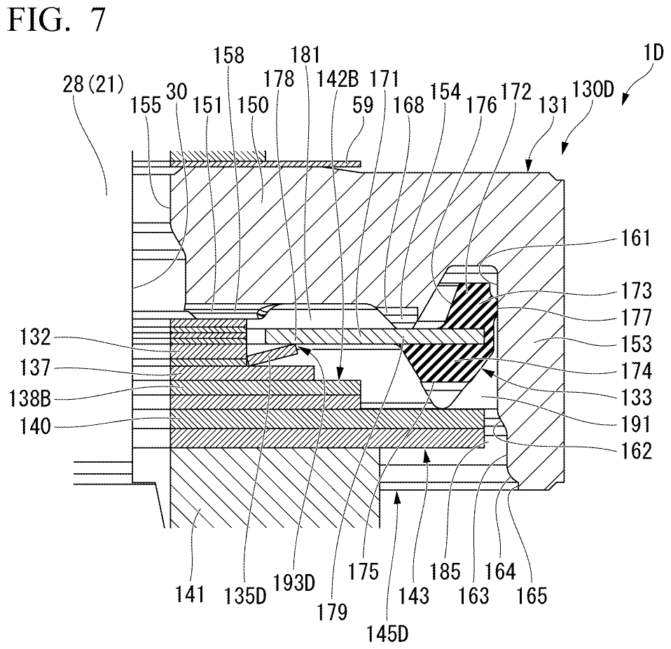

Next, a fifth embodiment will be described mainly on the basis of FIG. 7, focusing on the differences from the third embodiment. Further, portions common to those in the third embodiment will be denoted by the same terms and the same reference signs.

As illustrated in FIG. 7, a shock absorber 1D of the fifth embodiment includes a frequency sensitive mechanism 130D, which is partially different from the frequency sensitive mechanism 130B, instead of the frequency sensitive mechanism 130B.

The frequency sensitive mechanism 130D includes a valve case 145D, which is partially different from the valve case 145B, instead of the valve case 145B. The number of discs 132 in the valve case 145D is different from the number of discs 132 in the valve case 145B. A total thickness of all the discs 132 of the valve case 145D is larger than a total thickness of all the discs 132 of the valve case 145B. The flexible member 135B and the disc 136 are not provided in the valve case 145D.

The frequency sensitive mechanism 130D includes one flexible member 135D (plate-shaped member) that is separate from the valve case 145D. The flexible member 135D is provided between a valve disc 171 and a stopper disc 137 in an axial direction of a case member 131. The flexible member 135D is made of a metal. The flexible member 135D has a bored disc shape. The flexible member 135D is inclined so that it is positioned further toward one side in an axial direction thereof as it is positioned further toward an outer circumferential side in a radial direction thereof. The flexible member 135D has a circular tapered shape. In other words, the flexible member 135D is formed to be inclined such that a radially outer side is positioned on one side in the axial direction with respect to a radially inner side. The flexible member 135D has a constant outer diameter over the entire circumference and a constant radial width over the entire circumference. The flexible member 135D is elastically deformable, that is, bendable.

A mounting shaft part 28 of a rod 21 and a plurality of discs 132 are inserted through an inner circumferential side of the flexible member 135D. At that time, the flexible member 135D is directed such that an outer circumferential edge portion is positioned on the valve disc 171 side with respect to an inner circumferential edge portion in the axial direction. The flexible member 135D has a minimum inner diameter that allows the plurality of discs 132 to be disposed on a radially inner side thereof. That is, the minimum inner diameter of the flexible member 135D is slightly larger than an outer diameter of the plurality of discs 132. Even if the flexible member 135D is deformed into a flat plate shape, an inner diameter thereof is slightly larger than the outer diameter of the discs 132. Movement of the flexible member 135D by a predetermined value or more in the radial direction is restricted by the plurality of discs 132 disposed on the radially inner side.

The flexible member 135D is disposed on a side of the valve disc 171 opposite to a bottom part 150 in an axial direction of a valve member 133.

The flexible member 135D is elastically deformed in the axial direction between the valve disc 171 with a second support part 179 in contact with a seat part 154 and the stopper disc 137. Thereby, an end edge portion of the flexible member 135D on an outer circumferential side presses against a first support part 178 on an inner circumferential side of the valve disc 171 over the entire circumference. As a result, a gap between the flexible member 135D and the valve disc 171, that is, the valve member 133, is closed. The flexible member 135D is elastically deformed in the axial direction between the valve disc 171 and the stopper disc 137. Thereby, an end edge portion of the flexible member 135D on an inner circumferential side presses against the stopper disc 137 over the entire circumference. As a result, a gap between the flexible member 135D and the stopper disc 137, that is, a stopper 142B, is closed.

In the valve case 145D, a position of an end surface of a support member 143 on the bottom part 150 side in the axial direction of the case member 131 is the same as a position of the end surface of the support member 143 of the valve case 145B on the bottom part 150 side in the axial direction of the case member 131.

In the valve member 133, the first support part 178 on the inner circumferential side of the valve disc 171 is disposed between a protruding part 151 and the flexible member 135D in the axial direction. Then, the first support part 178 is supported by the flexible member 135D with one surface on a side opposite to the bottom part 150 in the axial direction in contact with the flexible member 135D. In the valve member 133, the first support part 178 of the valve disc 171 is movable between the protruding part 151 and the flexible member 135D in the axial direction of the case member 131, and moreover, is movable until the flexible member 135D is deformed into a flat plate shape.

Similarly to the valve member 133 of the frequency sensitive mechanism 130B, the valve member 133 of the frequency sensitive mechanism 130D is configured such that the second support part 179 is supported by the seat part 154, and a biasing part 174 is supported by the support member 143.

The valve member 133 is bendable such that the second support part 179 is separated from the seat part 154 while the first support part 178 remains in contact with the flexible member 135D. When bending in this manner, the valve member 133 is bent to move the second support part 179 to a side opposite to the bottom part 150 in the axial direction of the case member 131 with respect to the first support part 178.

The flexible member 135D is bendable together with the valve member 133. The flexible member 135D is bent in a direction opposite to the bottom part 150 due to movement and deformation of the valve member 133 to a side opposite to the seat part 154 in the axial direction. When the flexible member 135D bent as described above becomes a planar shape, the stopper 142B suppresses any further amount of bending of the flexible member 135D. Here, even if bending of the flexible member 135D is suppressed by the stopper 142B, the valve member 133 is bendable to move the second support part 179 further to a side opposite to the bottom part 150 in the axial direction of the case member 131 with respect to the first support part 178.

In the shock absorber 1D of the fifth embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 7, and a passage in a passage groove 158 of the case member 131. Then, the valve disc 171 of the valve member 133 bends the flexible member 135D, that is in contact therewith at the first support part 178, in a direction away from the bottom part 150 in the axial direction of the case member 131. In other words, the valve disc 171 compressively deforms the flexible member 135D in the axial direction of the case member 131 between itself and the stopper 142B. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135D as a fulcrum. In this way, the valve disc 171 is bent so that the second support part 179 is separated from the bottom part 150 in the axial direction of the case member 131 with respect to the first support part 178 using a contact point with the flexible member 135D as a fulcrum while moving away from the bottom part 150 in the axial direction of the case member 131.

As the introduction of the oil fluid L into the first chamber 181 further progresses, bending of the flexible member 135D in contact with the valve disc 171 is suppressed by the stopper 142B. Then, the valve disc 171 is bent in a tapered shape so that the second support part 179 is further separated from the bottom part 150 in the axial direction of the case member 131 with respect to the first support part 178 using a contact point with the flexible member 135D as a fulcrum while further compressively deforming the biasing part 174 in the axial direction of the case member 131 between the valve disc 171 and the support member 143.

Due to the movement and deformation of the valve disc 171 as described above, the valve member 133 increases a volume of the first chamber 181.

Here, a space between the first support part 178 of the valve disc 171 and the flexible member 135D is closed when they are in contact with each other and opens when they are separated from each other, thereby forming a check valve 193D that operates in the same manner as the check valve 193.

The shock absorber 1D of the fifth embodiment includes the flexible member 135D that is in contact with the first support part 178 of the valve member 133 and is bendable together with the valve member 133. Therefore, similarly to the shock absorber 1, the shock absorber 1D can enhance durability of the valve member 133 while securing a volume of the oil fluid L that can be received in the first chamber 181. At the same time, the shock absorber 1D can facilitate initial movement of the valve member 133 when the first chamber 181 receives the oil fluid L.

Also, in the shock absorber 1D, since the stopper 142B suppresses an amount of bending of the flexible member 135D, durability of the flexible member 135D can be enhanced as in the shock absorber 1.

Also, in the shock absorber 1D, since the valve member 133 can be bent even if bending of the flexible member 135D is suppressed by the stopper 142B, a volume of the oil fluid L that can be received in the first chamber 181 can be further secured as in the shock absorber 1.

Also, in the shock absorber 1D, since the flexible member 135D is formed of an annular plate-shaped member, an increase in costs due to provision of the flexible member 135D can be suppressed as in the shock absorber 1.

Also, in the shock absorber 1D, since the flexible member 135D is formed to be inclined such that the radially outer side is positioned on one side in the axial direction with respect to the radially inner side, a stress becoming excessive locally in the flexible member 135D can be suppressed. Thereby, durability of the flexible member 135D can be further enhanced.

### Sixth Embodiment

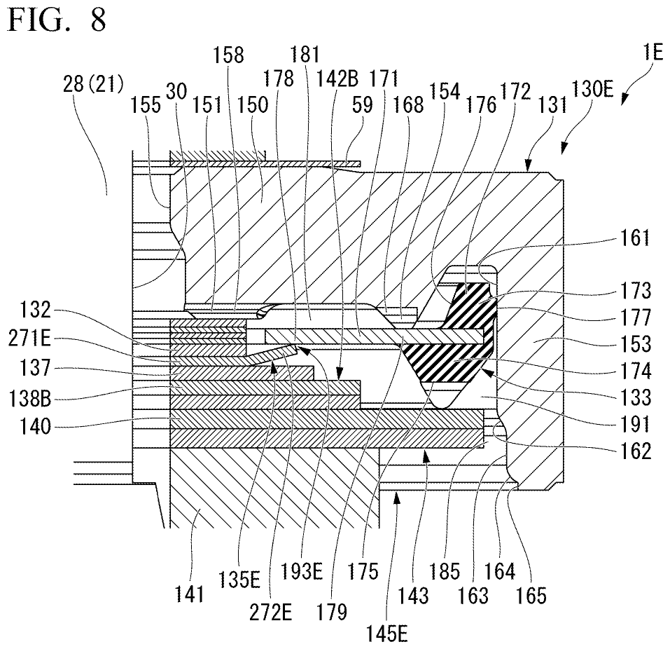

Next, a sixth embodiment will be described mainly on the basis of FIG. 8, focusing on the differences from the fifth embodiment. Further, portions common to those in the fifth embodiment will be denoted by the same terms and the same reference signs.

As illustrated in FIG. 8, a shock absorber 1E of the sixth embodiment includes a frequency sensitive mechanism 130E, which is partially different from the frequency sensitive mechanism 130D, instead of the frequency sensitive mechanism 130D.

The frequency sensitive mechanism 130E includes a valve case 145E, which is partially different from the valve case 145D, instead of the valve case 145D.

The number of discs 132 in the valve case 145E is different from the number of discs 132 in the valve case 145D. A total thickness of all the discs 132 of the valve case 145E is smaller than a total thickness of all the discs 132 of the valve case 145D.

The frequency sensitive mechanism 130E includes a flexible member 135E (plate-shaped member) instead of the flexible member 135D. The flexible member 135E constitutes the valve case 145E.

The flexible member 135E is made of a metal. The flexible member 135E has a base part 271E and a flexible part 272E.

The base part 271E has a bored circular flat plate shape with a constant thickness. The base part 271E has a constant inner diameter over the entire circumference and a constant radial width over the entire circumference. The radial width of the base part 271E is slightly larger than a radial width of the disc 132.

The flexible part 272E extends from an entire circumference of an outer circumferential edge portion of the base part 271E to the outside in a radial direction of the base part 271E and to one side in an axial direction of the base part 271E. The flexible part 272E has a circular tapered shape. In other words, the flexible part 272E is inclined so that it is positioned further toward one side in an axial direction thereof as it is positioned further toward an outer circumferential side in a radial direction thereof. The flexible part 272E has a constant outer diameter over the entire circumference and a constant radial width over the entire circumference. The flexible part 272E is elastically deformable, that is, bendable.

In the flexible member 135E, the base part 271E and the flexible part 272E are seamlessly and integrally formed. In the flexible member 135E, the base part 271E is sandwiched between a disc 132 at an end of all the discs 132 on a side opposite to a protruding part 151 and a stopper disc 137 of the stopper 142B, and is in contact with them. At that time, the flexible member 135E is directed so that the flexible part 272E extends to a valve disc 171 side with respect to the base part 271E in the axial direction. A total thickness of all the discs 132 between the protruding part 151 of a case member 131 and the base part 271E, and the base part 271E is equal to a total thickness of all the discs 132 of the valve case 145D.

A mounting shaft part 28 of a rod 21 is fitted to the flexible member 135E inside the base part 271E. Thereby, the flexible member 135E is made to coincide with the rod 21 in central axis.

In the valve case 145E, a position of an end surface of a support member 143 on a bottom part 150 side in the axial direction of the case member 131 is the same as a position of the end surface of the support member 143 of the valve case 145D on the bottom part 150 side in the axial direction of the case member 131.

The flexible member 135E is disposed on a side of the valve disc 171 opposite to the bottom part 150 in an axial direction of a valve member 133.

In the flexible member 135E, the flexible part 272E is elastically deformed in the axial direction between the valve disc 171 with a second support part 179 in contact with a seat part 154 and the stopper disc 137. Thereby, in the flexible member 135E, an end edge portion on an outer circumferential side of the flexible part 272E presses against a first support part 178 on an inner circumferential side of the valve disc 171 over the entire circumference. As a result, a gap between the flexible member 135E and the valve disc 171, that is, the valve member 133, is closed.

In the valve member 133, the first support part 178 on the inner circumferential side of the valve disc 171 is disposed between the protruding part 151 and the flexible member 135E in the axial direction. Then, the first support part 178 is supported by the flexible member 135E with one surface on a side opposite to the bottom part 150 in the axial direction in contact with the flexible member 135E. In the valve member 133, the first support part 178 of the valve disc 171 is movable between the protruding part 151 and the flexible member 135E in the axial direction of the case member 131, and moreover, is movable until the flexible part 272E of the flexible member 135E is deformed into a flat plate shape.

Similarly to the valve member 133 of the frequency sensitive mechanism 130D, the valve member 133 of the frequency sensitive mechanism 130E is configured such that the second support part 179 is supported by the seat part 154, and a biasing part 174 is supported by the support member 143.

The valve member 133 is bendable such that the second support part 179 is separated from the seat part 154 while the first support part 178 remains in contact with the flexible member 135E. When bending in this manner, the valve member 133 is bent to move the second support part 179 to a side opposite to the bottom part 150 in the axial direction of the case member 131 with respect to the first support part 178.

In the flexible member 135E, the flexible part 272E is bendable together with the valve member 133. In the flexible member 135E, the flexible part 272E is bent in a direction opposite to the bottom part 150 due to movement and deformation of the valve member 133 to a side opposite to the seat part 154 in the axial direction. When the flexible part 272E bent as described above becomes a planar shape, the stopper 142B suppresses any further amount of bending of the flexible part 272E. Here, even if bending of the flexible part 272E is suppressed by the stopper 142B, the valve member 133 is bendable to move the second support part 179 further to a side opposite to the bottom part 150 in the axial direction of the case member 131 with respect to the first support part 178.

In the shock absorber 1E of the sixth embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 8, and a passage in a passage groove 158 of the case member 131. Then, the valve disc 171 of the valve member 133 bends the flexible part 272E, that is in contact therewith at the first support part 178, in a direction away from the bottom part 150 in the axial direction of the case member 131. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible part 272E as a fulcrum. In this way, the valve disc 171 is bent so that the second support part 179 is separated from the bottom part 150 in the axial direction of the case member 131 with respect to the first support part 178 using a contact point with the flexible part 272E as a fulcrum while moving away from the bottom part 150 in the axial direction of the case member 131.

As the introduction of the oil fluid L into the first chamber 181 further progresses, bending of the flexible part 272E in contact with the valve disc 171 is suppressed by the stopper 142B. Then, the valve disc 171 is bent in a tapered shape so that the second support part 179 is further separated from the bottom part 150 in the axial direction of the case member 131 with respect to the first support part 178 using a contact point with the flexible part 272E as a fulcrum while further compressively deforming the biasing part 174 in the axial direction of the case member 131 between the valve disc 171 and the support member 143.

Due to the movement and deformation of the valve disc 171 as described above, the valve member 133 increases a volume of the first chamber 181.

Here, a space between the first support part 178 of the valve disc 171 and the flexible part 272E is closed when they are in contact with each other and opens when they are separated from each other, thereby forming a check valve 193E that operates in the same manner as the check valve 193.

The shock absorber 1E of the sixth embodiment includes the flexible member 135E that is in contact with the first support part 178 of the valve member 133 and is bendable together with the valve member 133. Therefore, similarly to the shock absorber 1, the shock absorber 1E can enhance durability of the valve member 133 while securing a volume of the oil fluid L that can be received in the first chamber 181. At the same time, the shock absorber 1E can facilitate initial movement of the valve member 133 when the first chamber 181 receives the oil fluid L.

Also, in the shock absorber 1E, since the stopper 142B suppresses an amount of bending of the flexible member 135E, durability of the flexible member 135E can be enhanced as in the shock absorber 1.

Also, in the shock absorber 1E, since the valve member 133 can be bent even if bending of the flexible member 135E is suppressed by the stopper 142B, a volume of the oil fluid L that can be received in the first chamber 181 can be further secured as in the shock absorber 1.

Also, in the shock absorber 1E, since the flexible member 135E is formed of an annular plate-shaped member, an increase in costs due to provision of the flexible member 135E can be suppressed as in the shock absorber 1.

Also, in the shock absorber 1E, since the base part 271E with which the flexible member 135E is fixed to the rod 21 and the flexible part 272E that is in contact with the valve member 133 are integrally formed, the number of parts can be reduced, and assembly is facilitated.

### Seventh Embodiment

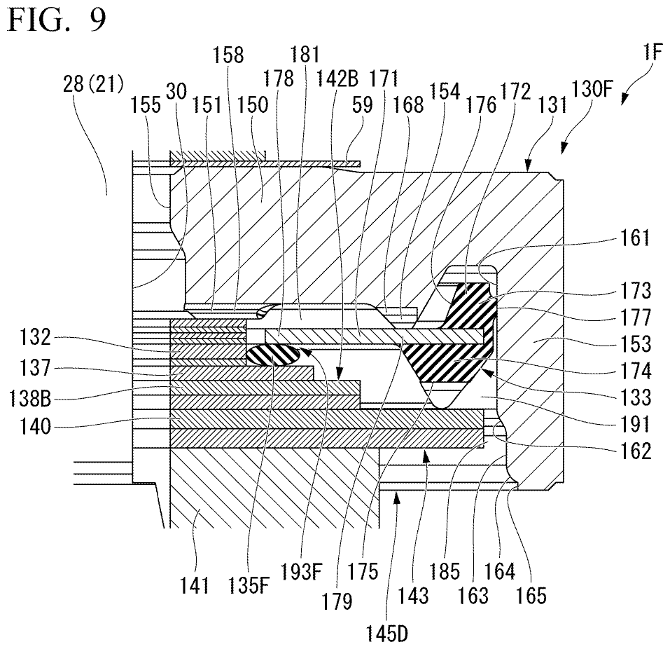

Next, a seventh embodiment will be described mainly on the basis of FIG. 9, focusing on the differences from the fifth embodiment. Further, portions common to those in the fifth embodiment will be denoted by the same terms and the same reference signs.

As illustrated in FIG. 9, a shock absorber 1F of the seventh embodiment includes a frequency sensitive mechanism 130F, which is partially different from the frequency sensitive mechanism 130D, instead of the frequency sensitive mechanism 130D.

The frequency sensitive mechanism 130F includes a flexible member 135F instead of the flexible member 135D. The flexible member 135F is also separate from a valve case 145D. The flexible member 135F is formed of an annular elastic member. The flexible member 135F is specifically made of rubber. The flexible member 135F is elastically deformable, that is, bendable.

A mounting shaft part 28 of a rod 21 and a plurality of discs 132 are inserted through an inner circumferential side of the flexible member 135F. The flexible member 135F has a minimum inner diameter that allows the plurality of discs 132 to be disposed on a radially inner side thereof. That is, the minimum inner diameter of the flexible member 135F is slightly larger than an outer diameter of the plurality of discs 132. Movement of the flexible member 135F by a predetermined value or more in a radial direction is restricted by the plurality of discs 132 disposed on the radially inner side.

The flexible member 135F is in contact with a valve disc 171 with a second support part 179 in contact with a seat part 154 and a stopper disc 137, and is elastically deformed between them in an axial direction. As a result, a gap between the flexible member 135F and the valve disc 171, that is, a valve member 133, is closed, and a gap between the flexible member 135F and the stopper disc 137, that is, a stopper 142B is closed.

In the valve member 133, a first support part 178 on an inner circumferential side of the valve disc 171 is disposed between a protruding part 151 and the flexible member 135F in the axial direction. Then, the first support part 178 is supported by the flexible member 135F with one surface on a side opposite to a bottom part 150 in the axial direction in contact with the flexible member 135F. In the valve member 133, the first support part 178 on the inner circumferential side of the valve disc 171 is movable between the protruding part 151 and the flexible member 135F, and moreover, is movable to compressively deform the flexible member 135F in an axial direction of a case member 131.

Similarly to the valve member 133 of the frequency sensitive mechanism 130D, the valve member 133 of the frequency sensitive mechanism 130F is configured such that the second support part 179 is supported by the seat part 154, and a biasing part 174 is supported by a support member 143.

The valve member 133 is bendable such that the second support part 179 is separated from the seat part 154 while the first support part 178 remains in contact with the flexible member 135F. When bending in this manner, the valve member 133 is bent to move the second support part 179 to a side opposite to the bottom part 150 in the axial direction of the case member 131 with respect to the first support part 178.

The flexible member 135F is bendable together with the valve member 133. Here, even if deformation of the flexible member 135F reaches a limit thereof, the valve member 133 is bendable to move the second support part 179 further to a side opposite to the bottom part 150 in the axial direction of the case member 131 with respect to the first support part 178.

In the shock absorber 1F of the seventh embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of the rod 21 illustrated in FIG. 9, and a passage in a passage groove 158 of the case member 131. Then, the valve disc 171 of the valve member 133 bends the flexible member 135F, that is in contact therewith at the first support part 178, in a direction away from the bottom part 150 in the axial direction of the case member 131. In other words, the valve disc 171 compressively deforms the flexible member 135F in the axial direction of the case member 131 between itself and the stopper 142B. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using a contact point with the flexible member 135F as a fulcrum. In this way, the valve disc 171 is bent so that the second support part 179 is separated from the bottom part 150 in the axial direction of the case member 131 with respect to the first support part 178 using a contact point with the flexible member 135F as a fulcrum while moving away from the bottom part 150 in the axial direction of the case member 131.

If the introduction of the oil fluid L into the first chamber 181 further progresses and the flexible member 135F deforms to a limit thereof, the valve disc 171 is bent in a tapered shape so that the second support part 179 is further separated from the bottom part 150 in the axial direction of the case member 131 with respect to the first support part 178 using a contact point with the flexible member 135F as a fulcrum while further compressively deforming the biasing part 174 in the axial direction of the case member 131 between the valve disc 171 and the support member 143.

Due to the movement and deformation of the valve disc 171 as described above, the valve member 133 increases a volume of the first chamber 181.

Here, a space between the first support part 178 of the valve disc 171 and the flexible member 135F is closed when they are in contact with each other and opens when they are separated from each other, thereby forming a check valve 193F that operates in the same manner as the check valve 193.

The shock absorber 1F of the seventh embodiment includes the flexible member 135F that is in contact with the first support part 178 of the valve member 133 and is bendable together with the valve member 133. Therefore, similarly to the shock absorber 1, the shock absorber 1F can enhance durability of the valve member 133 while securing a volume of the oil fluid L that can be received in the first chamber 181. At the same time, the shock absorber 1F can facilitate initial movement of the valve member 133 when the first chamber 181 receives the oil fluid L.

Also, in the shock absorber 1F, since the valve member 133 can be bent even if the flexible member 135F is deformed to a limit thereof, a volume of the oil fluid L that can be received in the first chamber 181 can be further secured as in the shock absorber 1.

Also, in the shock absorber 1F, since the flexible member 135F is formed of an annular elastic member, sealing performance of the check valve 193F can be improved.

### Eighth Embodiment

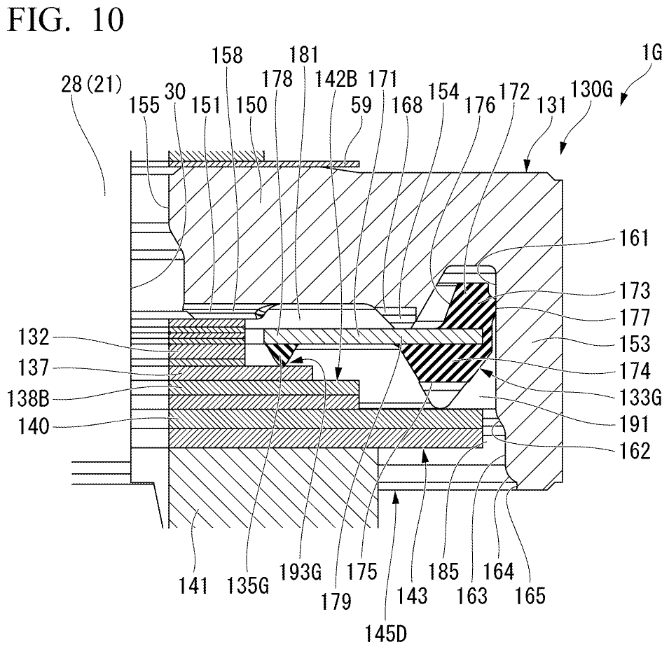

Next, an eighth embodiment will be described mainly on the basis of FIG. 10, focusing on the differences from the fifth embodiment. Further, portions common to those in the fifth embodiment will be denoted by the same terms and the same reference signs.

As illustrated in FIG. 10, a shock absorber 1G of the eighth embodiment includes a frequency sensitive mechanism 130G, which is partially different from the frequency sensitive mechanism 130D, instead of the frequency sensitive mechanism 130D.

The frequency sensitive mechanism 130G includes a valve member 133G (first valve), which is partially different from the valve member 133, instead of the valve member 133. The frequency sensitive mechanism 130G includes a flexible member 135G, which is partially different from the flexible member 135D, instead of the flexible member 135D. The flexible member 135G constitutes the valve member 133G.

The flexible member 135G is formed of an annular elastic member. The flexible member 135G is specifically made of rubber. The flexible member 135G is elastically deformable, that is, bendable. The flexible member 135G is adhered to an inner circumferential side of a valve disc 171. The flexible member 135G is adhered to the same side of the valve disc 171 as a biasing part 174 in an axial direction. Thereby, the flexible member 135G closes a gap between itself and the valve disc 171. The flexible member 135G has an annular shape. The flexible member 135G is provided integrally with the valve disc 171 by being baked into the valve disc 171. An outer diameter of the flexible member 135G decreases and an inner diameter thereof increases with distance away from the valve disc 171 in the axial direction. Thereby, a cross-sectional shape of the flexible member 135G in a plane including a central axis thereof is a tapered single chevron shape that becomes thinner with distance away from the valve disc 171 in the axial direction.

In the valve member 133G, the flexible member 135G is in contact with a stopper disc 137 to be elastically deformed in the axial direction with a second support part 179 in contact with a seat part 154. Thereby, a gap between the flexible member 135G and the stopper disc 137, that is, the stopper 142B, is closed.

A first support part 178 on an inner circumferential side of the valve disc 171 of the valve member 133G is supported by the stopper disc 137 at one surface on a side opposite to a bottom part 150 in the axial direction via the flexible member 135G. In the valve member 133G, the first support part 178 of the valve disc 171 is movable together with the flexible member 135G between the protruding part 151 and the stopper disc 137 in an axial direction of a case member 131, and moreover, is movable to deform the flexible member 135G.

Similarly to the valve member 133 of the frequency sensitive mechanism 130D, the valve member 133G of the frequency sensitive mechanism 130G is configured such that the second support part 179 is supported by the seat part 154, and the biasing part 174 is supported by a support member 143.

The valve member 133G is bendable such that the second support part 179 is separated from the seat part 154 while the flexible member 135G remains in contact with the stopper disc 137. When bending in this manner, the valve member 133 is bent to move the second support part 179 to a side opposite to the bottom part 150 in the axial direction of the case member 131 with respect to the first support part 178. The flexible member 135G is bendable together with the valve disc 171. Here, even if deformation of the flexible member 135G reaches a limit thereof, the valve disc 171 is bendable to move the second support part 179 further to a side opposite to the bottom part 150 in the axial direction of the case member 131 with respect to the first support part 178.

In the shock absorber 1G of the eighth embodiment, during an extension stroke, an oil fluid L from an upper chamber 19 (see FIG. 2) is introduced into a first chamber 181 via a first passage 43 (see FIG. 2), a passage in a notch 81 of a disc 50 (see FIG. 2), a passage in a groove part 30 of a rod 21 illustrated in FIG. 10, and a passage in a passage groove 158 of the case member 131. Then, the valve disc 171 of the valve member 133G bends the flexible member 135G in a direction away from the bottom part 150 in the axial direction of the case member 131. In other words, the valve disc 171 compressively deforms the flexible member 135G in the axial direction of the case member 131 between itself and the stopper 142B. At the same time, the valve disc 171 compressively deforms the biasing part 174 that is in contact with the support member 143 in the axial direction of the case member 131 between itself and the support member 143. At the same time, the valve disc 171 is bent in a tapered shape so that the second support part 179 is separated from the bottom part 150 in the axial direction of the case member 131 with respect to the first support part 178 using the flexible member 135G as a fulcrum. In this way, the valve disc 171 is bent so that the second support part 179 is separated from the bottom part 150 in the axial direction of the case member 131 with respect to the first support part 178 using the flexible member 135G as a fulcrum while moving away from the bottom part 150 in the axial direction of the case member 131.

If the introduction of the oil fluid L into the first chamber 181 further progresses and the flexible member 135G deforms to a limit thereof, the valve disc 171 is bent in a tapered shape so that the second support part 179 is further separated from the bottom part 150 in the axial direction of the case member 131 with respect to the first support part 178 using the flexible member 135G as a fulcrum while further compressively deforming the biasing part 174 in the axial direction of the case member 131 between the valve disc 171 and the support member 143.

Due to the movement and deformation of the valve disc 171 as described above, the valve member 133G increases a volume of the first chamber 181.

Here, a space between the flexible member 135G of the valve member 133G and the stopper disc 137 is closed when they are in contact with each other and opens when they are separated from each other, thereby forming a check valve 193G that operates in the same manner as the check valve 193.

The shock absorber 1G of the eighth embodiment includes the flexible member 135G that is adhered to the first support part 178 of the valve member 133 while in contact therewith and is bendable together with the valve member 133. Therefore, similarly to the shock absorber 1, the shock absorber 1G can enhance durability of the valve member 133 while securing a volume of the oil fluid L that can be received in the first chamber 181. At the same time, the shock absorber 1G can facilitate initial movement of the valve member 133 when the first chamber 181 receives the oil fluid L.

Also, in the shock absorber 1G, since the valve member 133G can be bent even if the flexible member 135G is deformed to a limit thereof, a volume of the oil fluid L that can be received in the first chamber 181 can be further secured as in the shock absorber 1.

Also, in the shock absorber 1G, since the flexible member 135G is formed of an annular elastic member, sealing performance of the check valve 193G can be improved.

Further, in the first to eighth embodiments, a hydraulic shock absorber has been illustrated as an example, but the above-described structure can also be employed for a shock absorber using water or air as a working fluid.

### INDUSTRIAL APPLICABILITY

According to the above-described aspects, it is possible to provide a shock absorber in which durability of a bendable plate-shaped valve can be enhanced. Therefore, industrial applicability is high.

### REFERENCE SIGNS LIST

1, 1A to 1G Shock absorber
2 Cylinder
18 Piston
19 Upper chamber
20 Lower chamber
21 Rod
133, 133G Valve member (first valve)
135, 135A to 135E Flexible member (plate-shaped member)
135F, 135G Flexible member (elastic member)
142, 142A to 142D Stopper
174 Biasing part
178 First support part
179 Second support part
191 Second passage (passage)
261C to 263C Plate-shaped stopper member
251B, 252B Annular member

1. A shock absorber comprising:
a cylinder in which a working fluid is sealed;
a piston fitted in the cylinder to be slidable and partitioning an inside of the cylinder into two chambers;
a rod having a first end portion fastened to the piston and a second end portion protruding from the cylinder;
a passage allowing communication between one chamber and another chamber in the cylinder;
a bendable plate-shaped first valve including:
a first support part provided in the passage and supported at one surface in an axial direction on a radially inner side;
a second support part disposed on a radially outer side with respect to the first support part and supported at one surface on a side opposite to the first support part in the axial direction; and
a biasing part at least a part of which is provided on a radially outer side of the second support part to bias toward the second support part side; and
a flexible member provided to be separable from the first support part, and being bendable together with the first valve while being in contact with the first part.

2. The shock absorber according to claim 1, further comprising a stopper suppressing an amount of bending of the flexible member.

3. The shock absorber according to claim 2, wherein the first valve is bendable even if bending of the flexible member is suppressed by the stopper.

4. The shock absorber according to claim 2, wherein
the stopper includes a plurality of plate-shaped stopper members which are all formed of an annular plate-shaped member, and
the plurality of plate-shaped stopper members are configured such that an outer diameter of the plate-shaped stopper member provided on a side opposite to the first valve is smaller than an outer diameter of the plate-shaped stopper member provided on the first valve side.

5. The shock absorber according to claim 1, wherein the flexible member is formed of an annular elastic member.

6. The shock absorber according to claim 1, wherein the flexible member is formed of an annular plate-shaped member.

7. The shock absorber according to claim 5, wherein the flexible member is formed to be inclined such that a radially outer side is positioned on one side in an axial direction with respect to a radially inner side.

8. The shock absorber according to claim 6, wherein
the plate-shaped member includes a plurality of annular members, and
the plurality of annular members are configured such that an outer diameter of an annular member provided on a side opposite to the first valve is smaller than an outer diameter of an annular member provided on the first valve side.
